(19) United States
(12) Patent Application Publication
(10) Pub. No.: US 2024/0202619 A1
(43) Pub. Date: Jun. 20, 2024

(54) METHODS, SYSTEMS AND COMPUTER READABLE MEDIA FOR AUTOMATICALLY SELECTING SAMPLE TASKS AND OBTAINING CORRECT ANSWERS FOR WORKER COMPETENCY TESTS WITHOUT EXPERT RESPONSE THROUGH CROWDSOURCING

(71) Applicant: SELECT STAR, INC., Daejeon (KR)

(72) Inventors: Se Yeob KIM, Seoul (KR); Doyeon KIM, Seoul (KR); Yeonok CHO, Seoul (KR); Silro JEONG, Incheon (KR)

(21) Appl. No.: 17/910,807

(22) PCT Filed: Jan. 21, 2022
(86) PCT No.: PCT/KR2022/001086

§ 371 Date: Sep. 10, 2022

(30) Foreign Application Priority Data
Oct. 15, 2021 (KR) 10-2021-0137021

(51) Int. Cl. G06Q 10/0631

(52) U.S. Cl. CPC G06Q 10/063112

(57) ABSTRACT

The present invention relates to a method, a system and a computer readable medium for automatically selecting sample tasks and obtaining correct answers for worker competency tests without expert response through crowdsourcing, and more particularly, to a method, a system and a computer readable medium for automatically selecting sample tasks and obtaining correct answers for worker competency tests without expert response through crowdsourcing in which, when a worker processes a work through the crowdsourcing, reliability information for each worker is updated and a selection of a sample task and a test task labeled with a difficulty level are automatically obtained based on a correct answer probability.

### BACKGROUND OF THE INVENTION

### 1. Field of the Invention

The present invention relates to a method, a system and a computer readable medium for automatically selecting sample tasks and obtaining correct answers for worker competency tests without expert response through crowdsourcing, and more particularly, to a method, a system and a computer readable medium for automatically selecting sample tasks and obtaining correct answers for worker competency tests without expert response through crowdsourcing, in which, when a worker processes a work through the crowdsourcing, reliability information for each worker is updated and a selection of a sample task and a test task labeled with a difficulty level are automatically obtained based on a correct answer probability.

### 2. Description of the Related Art

Recently, as technologies related to artificial intelligence have been developed and various solutions using the artificial intelligence have been developed, interest in methods of collecting or building data for learning artificial intelligence is increasing. Since the artificial intelligence, especially deep learning-based artificial intelligence has the better performance when the amount of data for learning is greater and the quality of the data is higher, it is increasingly important to ensure high-quality data rather than simply ensuring data for learning.

In general, in the case of data for training artificial intelligence, labeled data is required, such as separately labeling vehicle regions in an image containing vehicles. Accordingly, in addition to simply collecting data, it is necessary to separately label the collected data through manual work and the like, and this requires a lot of resources, such as securing human power for performing labeling and time requirement for the labeling, in securing learning data.

Accordingly, methods for building data based on crowdsourcing have been proposed recently in order to efficiently ensure a large amount of labeled training data. According to the crowdsourcing, work such as data is provided to an unspecified number of workers, the workers perform a task such as labeling on the work, task results performed by the workers are reviewed by multiple reviewers, pieces of labeled data are finally established, and the workers having labeled the corresponding data are rewarded with respect to the data finally established through the review.

In addition, because quality of task results for the same work may vary depending on the ability of a worker, the role of the reviewer reviewing the task results is important in order to build labeled data with high quality. Among the conventional methods of reviewing a task result of a worker, there is a method of determining the reliability on a corresponding task result and the worker based on the review results on one task result reviewed by multiple reviewers. However, in the case of a method in which the reviewer reviews all task results, the cost for the reviewers is burdened in addition to the cost for the worker because a plurality of reviewers are required to be assigned to all tasks in order to review the task results. In addition, since the reliability of the review result according to the reviewer's review competency and sincerity is required to be determined, a separate step is required to be additionally performed to verify the reliability. As a result, because of the cost increase due to the reviewer cost and the additional steps for verifying the reviewers, the method in which multiple reviewers review on a task result may cause an increase in cost and a delay in time for the project.

As a conventional method for solving the above problem, there is a method in which reviewers do not review all tasks, but review only specific tasks selected based on the worker's work competence or reliability, or task inconsistent with preset conditions are automatically rejected to reduce the burden on the reviewers.

However, even in the above method, the project cannot be carried out only by the worker without reviewers or a separate expert, and a separate review process by a reliable reviewer is required to determine the reliability of the worker and task results.

Accordingly, the need to develop a new method is emerging for reviewing task results on a work and automatically deriving the reliability of a worker without a separate expert.

### SUMMARY OF THE INVENTION

The present invention relates to a method, a system and a computer readable medium for automatically selecting sample tasks and obtaining correct answers for worker competency tests without expert response through crowdsourcing, and more particularly, provides a method, a system and a computer readable medium for automatically selecting sample tasks and obtaining correct answers for worker competency tests without expert response through crowdsourcing, in which, when a worker processes a work through the crowdsourcing, reliability information for each worker is updated and a selection of a sample task and a test task labeled with a difficulty level are automatically obtained based on a correct answer probability.

In order to solve the above problem, one embodiment of the present invention provides a method for automatically deriving a test task labeled with a correct answer and a difficulty level of the task through crowdsourcing performed on a computing device having at least one processor and at least one memory, and the method includes: an initial step including: a task result receiving step of receiving task results of initial multiple workers on multiple unit tasks; an initial task processing step of deriving a comprehensive task result of each unit task based on initial information including the task results of the initial multiple workers, and deriving reliability information on each of the initial multiple workers based on some or all of the comprehensive task result and the initial information; an initial correct answer probability deriving step of deriving a correct answer probability for each answer for each of multiple unit tasks based on the reliability information on each of the initial multiple workers determined in the initial task processing step and the task results of the initial multiple workers; an initial test classifying step of classifying at least one unit task, in which the correct answer probability for each answer meets a preset criterion among multiple unit tasks, into a test task candidate set; and an initial worker adding step of assigning an undecided task, which includes at least one unit task in which the correct answer probability for each answer does not meet the preset criterion among multiple unit tasks, to at least one additional worker; and an additional step of receiving a task result by the additional worker on the undecided task, classifying a part of the undecided task into a test task candidate set, and classifying another part of the undecided tasks into the undecided task again.

According to one embodiment of the present invention, the additional step may include: an additional task result receiving step of receiving a task result by at least one additional worker for at least one undecided task; an additional task processing step of deriving the comprehensive task result of each undecided task based on the initial information including the task results by the initial multiple workers and the additional worker with respect to the at least one undecided task, and deriving reliability information on each of the initial multiple workers and the at least one additional worker based on some or all of the comprehensive task result and the initial information; an additional correct answer probability deriving step of deriving a correct answer probability for each answer for each of multiple undecided tasks, based on the reliability information on each of the initial multiple workers and the at least one additional worker determined in the additional task processing step, and based on the task results by the initial multiple workers and the at least one additional worker; an additional test classifying step of classifying at least one undecided task, in which the correct answer probability for each answer meets a preset criterion among multiple undecided tasks, into a test task candidate set; and an additional worker adding step of reassigning at least one undecided tasks, in which the correct answer probability for each answer does not meet the preset criteria among multiple undecided tasks, to the at least one additional worker.

According to one embodiment of the present invention, the additional step may be performed two times or more.

According to one embodiment of the present invention, the additional step may be repeatedly performed N times (N is a natural number equal to or greater than 2) until the number of remaining undecided tasks meets the preset criterion.

According to one embodiment of the present invention, the method for automatically deriving a test task labeled with a correct answer and a difficulty level of the task further includes a sample difficulty level determining step, wherein, in the sample difficulty level determining step, a difficulty level of the unit task for each of the at least one unit task included in the test task candidate set may be determined based on the number of times of performing the task.

According to one embodiment of the present invention, in the sample difficulty level determining step, the difficulty level of the unit task may be set to be higher as the number of times of performing the task is increased.

According to one embodiment of the present invention, in the sample difficulty level determining step, the additional step for the unit task in which the number of times of performing the task exceeds the maximum number of times of performing the task may be stopped and the highest a difficulty level may be assigned to the unit task.

According to one embodiment of the present invention, each of the at least one unit task included in the test task candidate set may be labeled with corresponding a difficulty level information. The method for automatically deriving a test task labeled with a correct answer and a difficulty level of the task further includes a sample set generating step, wherein a sample set generated in the sample set generating step includes at least two sub-sample sets having different difficulties, and, in the sample set generating step, some or all of the at least one unit task included in the test task candidate set may be assigned to a corresponding sub-sample set based on the difficulty level information.

According to one embodiment of the present invention, in the initial processing step, reliability information on each of the initial multiple workers may be repeatedly updated until error values of the comprehensive task results of the initial multiple workers converges to a specific value.

According to one embodiment of the present invention, the preset criterion may include whether the at least one correct answer probability for each correct answer exceeds a first threshold value.

According to one embodiment of the present invention, the preset criterion may include whether at least one indicator for a difference between multiple correct answers probabilities exceeds a second threshold value.

In order to solve the above problem, one embodiment of the present invention provides a system for automatically deriving a test task labeled with a correct answer and a difficulty level of the task through crowdsourcing, and the system performs the initial steps including: a task result receiving step of receiving task results of initial multiple workers on multiple unit tasks; an initial task processing step of deriving a comprehensive task result of each unit task based on initial information including the task results of the initial multiple workers, and deriving reliability information on each of the initial multiple workers based on some or all of the comprehensive task result and the initial information; an initial correct answer probability deriving step of deriving a correct answer probability for each answer for each of multiple unit tasks based on the reliability information on each of the initial multiple workers determined in the initial task processing step and the task results of the initial multiple workers; an initial test classifying step of classifying at least one unit task, in which the correct answer probability for each answer meets a preset criterion among multiple unit tasks, into a test task candidate set; and an initial worker adding step of assigning an undecided task, which includes at least one unit task in which the correct answer probability for each answer does not meet the preset criterion among multiple unit tasks, to at least one additional worker.

In order to solve the above problem, one embodiment of the present invention provides a computer-readable medium for implementing a method for automatically deriving a test task labeled with a correct answer and a difficulty level of the task through crowdsourcing performed on a computing device having at least one processor and at least one memory, and the computer-readable medium stores instructions for allowing the computing device to perform the initial steps including: a task result receiving step of receiving task results of initial multiple workers on multiple unit tasks; an initial task processing step of deriving a comprehensive task result of each unit task based on initial information including the task results of the initial multiple workers, and deriving reliability information on each of the initial multiple workers based on some or all of the comprehensive task result and the initial information; an initial correct answer probability deriving step of deriving a correct answer probability for each answer for each of multiple unit tasks based on the reliability information on each of the initial multiple workers determined in the initial task processing step and the task results of the initial multiple workers; an initial test classifying step of classifying at least one unit task, in which the correct answer probability for each answer meets a preset criterion among multiple unit tasks, into a test task candidate set; and an initial worker adding step of assigning an undecided task, which includes at least one unit task in which the correct answer probability for each answer does not meet the preset criterion among multiple unit tasks, to at least one additional worker.

According to one embodiment of the present invention, since reliability information is calculated based on the task results performed by a plurality of workers on the work including each unit task, the comprehensive task results for task results can be derived with weights on the reliability information (review/task ability) of the worker. Even when the worker has not previously performed the task, the reliability information can be calculated based on the currently performed task results.

According to one embodiment of the present invention, the task result inference step and the reliability information update step may be repeatedly performed to update the reliability information of the worker so that the error value between the task result for each worker and the first comprehensive task result for the unit task corresponding to the task result for each worker is minimized, so that the reliability information for accurately reflecting the task results performed by a plurality of workers can be derived.

According to one embodiment of the present invention, a plurality of initial reliability tests may be provided to the workers, and the initial reliability information for each worker may be derived based on the test results performed by the worker, so that the initial value for updating the reliability information for each worker can be effectively allocated.

According to one embodiment of the present invention, a plurality of initial reliability tests are provided to the worker between the works including the unit task performed by the worker, so that the initial reliability information can be derived while considering the worker's concentration that changes as the worker continuously performs the tasks.

According to one embodiment of the present invention, since reliability information is calculated based on the task results performed by a plurality of workers on the work including each unit task, a sample task for the worker competence test can be automatically selected based on the task results and the reliability information on the worker.

According to one embodiment of the present invention, the initial correct answer probability deriving step and the initial test classifying step are repeatedly performed to automatically classify the unit task that meet preset criterion into the test task candidate set, so that the reliability on the task classified into the test task candidate set can be ensured among the task results performed by multiple workers.

According to one embodiment of the present invention, since a sample set for worker competence tests on multiple tasks is automatically generated, an error with the correct answer generated by the worker reliability inference scheme is compared, so that the accuracy of a review algorithm can be determined.

According to one embodiment of the present invention, since a sample set for worker competence tests on multiple tasks is automatically generated, reviews on task results by super collection users who do not need reviews may be omitted, so that costs for producing data can be reduced.

According to one embodiment of the present invention, the process of selecting a sample task and obtaining a corresponding answer for the worker competence test on multiple tasks can be performed without an examiner or expert answer, so that costs for producing data can be reduced.

### BRIEF DESCRIPTION OF THE DRAWINGS

FIG. 1 schematically shows a system for establishing data in a crowdsourcing scheme according to one embodiment of the present invention.

FIG. 2 schematically shows the internal configuration of a computing device according to one embodiment of the present invention.

FIG. 3 schematically shows detailed processes of the method for deriving the review result by reflecting the reliability information of the reviewer according to one embodiment of the present invention.

FIG. 4 schematically shows the reliability information according to one embodiment of the present invention.

FIGS. 5A and 5B schematically show a process of updating reliability information according to review results of a plurality of reviewers for task results of a plurality of unit tasks according to one embodiment of the present invention.

FIGS. 6A, 6B and 6C schematically show a process of deriving initial reliability information on a plurality of reviewers by receiving test results on a plurality of initial reliability tests of a plurality of reviewers according to one embodiment of the present invention.

FIG. 7 schematically shows the internal configuration of a computing device for implementing a method for automatically selecting a sample task for a worker competency test and obtaining a correct answer thereof according to one embodiment of the present invention.

FIG. 8 schematically shows detailed processes of an initial step of classifying multiple unit tasks into a test task candidate set according to the correct answer probability for each answer according to one embodiment of the present invention.

FIG. 9 schematically shows detailed processes of an additional step of classifying multiple undecided tasks into a test task candidate set according to the updated correct answer probabilities for each answer according to one embodiment of the present invention.

FIG. 10 schematically shows correct answer probability for each worker, unit task, and answer according to one embodiment of the present invention.

FIG. 11 schematically shows a process of calculating a difficulty level based on the correct answer probability for each answer and classifying the test task candidate set according to one embodiment of the present invention.

FIG. 12 schematically shows a process of setting task a difficulty level based on the number of times of performing a task according to one embodiment of the present invention.

FIGS. 13A, 13B and 13C schematically show a process of setting task a difficulty level and generating a sample set based on the number of times of performing a task according to one embodiment of the present invention.

FIG. 14 schematically shows internal components of the computing device according to one embodiment of the present invention.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect (s) may be carried out without the specific details. The following description and accompanying drawings will be set forth in detail for specific illustrative aspects among one or more aspects. However, the aspects are merely illustrative, some of various ways among principles of the various aspects may be employed, and the descriptions set forth herein are intended to include all the various aspects and equivalents thereof.

In addition, various aspects and features will be presented by a system that may include a plurality of devices, components and/or modules or the like. It will also be understood and appreciated that various systems may include additional devices, components and/or modules or the like, and/or may not include all the devices, components, modules or the like recited with reference to the drawings.

The term “embodiment”, “example”, “aspect”, “exemplification”, or the like as used herein may not be construed in that an aspect or design set forth herein is preferable or advantageous than other aspects or designs. The terms ‘unit’, ‘component’, ‘module’, ‘system’, ‘interface’ or the like used in the following generally refer to a computer-related entity, and may refer to, for example, hardware, software, or a combination of hardware and software.

In addition, the terms “include” and/or “comprise” specify the presence of the corresponding feature and/or component, but do not preclude the possibility of the presence or addition of one or more other features, components or combinations thereof.

In addition, the terms including an ordinal number such as first and second may be used to describe various components, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, in embodiments of the present invention, unless defined otherwise, all terms used herein including technical or scientific terms have the same meaning as commonly understood by those having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

### 1. Method for Deriving Task Results by Reflecting Reliability Information of Workers Processing Works Collected Through Crowdsourcing

Prior to describing the method for automatically selecting sample tasks and obtaining correct answers for worker competency tests without expert response according to the present invention, a method for deriving task results by reflecting reliability information of workers processing works collected through crowdsourcing will be described.

A method, a system, and a computer-readable medium for deriving task results by reflecting reliability information of a worker processing a work collected through crowdsourcing of the present invention may be used for the purpose of deriving task results for various types of tasks, such as setting a border of objects, performed by workers based on crowdsourcing, by reflecting the reliability information of the workers.

In addition, specifically, the present invention may be used to derive task results, in the form of selecting a specific option among multiple options, on tasks performed by workers, with reflection of reliability information on the workers.

In addition, the task may refer to a task result previously performed by a primary worker on a work provided through a computing device performing the present invention, or review work performed by a secondary worker (reviewer) on a task result previously performed by the primary worker provided through an external separate computing device.

More specifically, according to the present invention, the secondary worker (reviewer) may select whether the task result performed by the primarily worker is a correct answer or not (T/F), so as to be used to derive a task result on a task to be reviewed.

In addition, specifically, the present invention may be used to derive task results of tasks performed by workers in the form of selecting a specific option among multiple options by reflecting reliability information of the workers.

In addition, the work may refer to review work performed by a secondary worker (reviewer) on a task result previously performed by a primary worker on a work provided through a computing device performing the present invention, or a task result previously performed by the primary worker provided through an external separate computing device.

More specifically, the present invention may also be used when a secondary worker (reviewer) selects whether a task result performed by a primary worker is correct or not (T/F), thereby deriving a task result on a task of performing a review.

In addition, the task may be used for the purpose of selecting a sample task for a worker competency test with respect to the task results of the workers and obtaining a correct answer.

In addition, specifically, the present invention may be used for the purpose to derive a task difficulty level based on the number of times of performing tasks by the workers and generate a work sample set according to a preset criterion based on the task difficulty level.

In addition, hereinafter, in order to facilitate the description of the present invention, as one embodiment of the present invention, a method of derive a review result subjected to a review based on reliability information of a corresponding worker after a secondary worker (reviewer) selects whether a task result performed by a primary worker is a correct answer or not (T/F) will be described. In other words, the reviewer described below may be included in a worker performing a review belonging to a specific type of task. However, the present invention is not limited to the scope of the following description, and the present invention may be used to derive task results on various tasks performed through the above-described crowdsourcing.

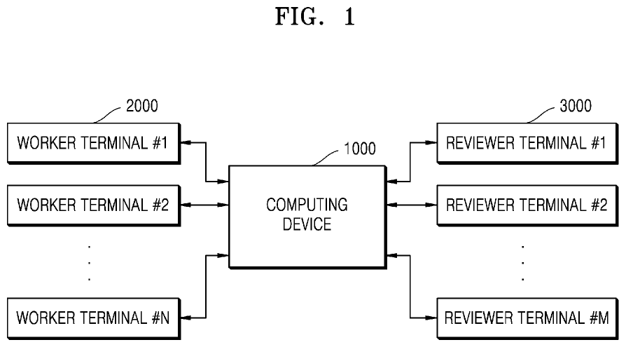

FIG. 1 schematically shows a system for establishing data in a crowdsourcing scheme according to one embodiment of the present invention.

As shown in FIG. 1, the system for constructing data, preferably, labeled learning data, in a crowdsourcing manner includes: a plurality of worker terminals 2000 for performing tasks on works, a plurality of reviewer terminals 3000 for reviewing the task results performed by the workers, and a computing device 1000 communicating with the worker terminals 2000 and the reviewer terminals 3000.

The worker terminal 2000 communicates with the computing device 1000 to receive at one work on which tasks may be performed, and transmits a task result inputted by the worker on the corresponding work to the computing device 1000. In addition, the worker terminal 2000 may display an interface for displaying the work to allow the worker to perform the task on the provided work, and the worker may input task results for the work through the interface displayed on the worker terminal 2000.

In addition, when the task result is transmitted to the computing device 1000 through the worker terminal 2000, or reviews on the task result by multiple reviewers are completed after the task result is transmitted the worker may receive a predetermined reward from the computing device 1000. Specifically, the computing device 1000 may provide a predetermined reward according to the task result to an account corresponding to the worker having provided the task result, and the worker terminal 2000 may display the reward provided to the corresponding account according to an input of the worker. In addition, regarding the predetermined reward, the size of the reward may be determined according to amounts of performed tasks on the work and reviewed results on the performed task result, and accordingly, the reward may be a motivation for enabling the workers to output high-quality task results.

The reviewer terminal 3000 communicates with the computing device 1000 to receive one or more task results performed by a plurality of workers, and transmits the review results inputted by the reviewers on the corresponding task results to the computing device 1000. In addition, the reviewer terminal 3000 may display an interface for displaying the task results so that the reviewer performs the review on the provided task results, and the reviewer may input the review result according to the review on the task results via the interface displayed on the reviewer terminal 3000.

In addition, in another embodiment of the present invention, the reviewer in addition to the worker also may receive a predetermined reward from the computing device 1000 according to the review result performed by the reviewer.

Accordingly, the reviewer terminal 3000 and the reviewer terminal 3000 may be various types of computing devices capable of communicating with the computing device 1000, such as a smartphone or PC, to display information and receiving input from a user. In addition, the reviewer terminal 3000 and the reviewer terminal 3000 may be installed therein with a web browser capable of executing an application or web page for communicating with the computing device 1000, and the communication with the computing device 1000 may be performed by executing the application or the web page.

In addition, the application or the web page may include a separate application or a separate web page for the workers, and a separate application or a separate web page for the reviewers. Whereas, the application or the web page may include an application or web page commonly used by both of the worker and the reviewer, and different information according to an account type may be displayed upon log-in with the account type corresponding to each of the worker and the reviewer.

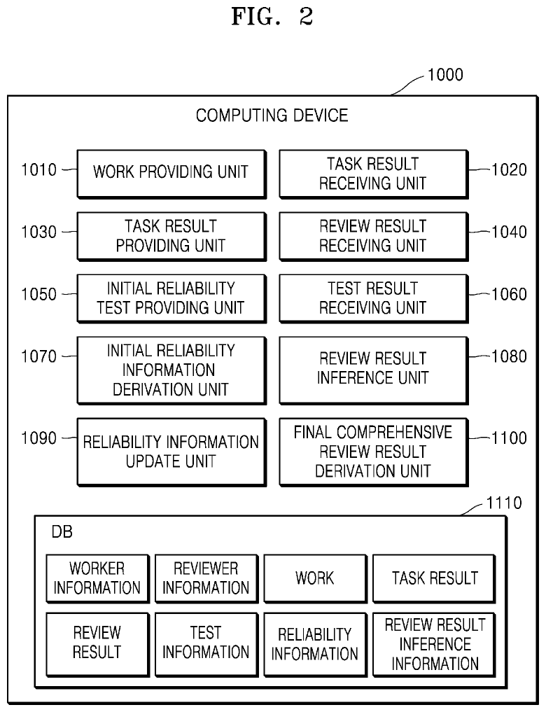

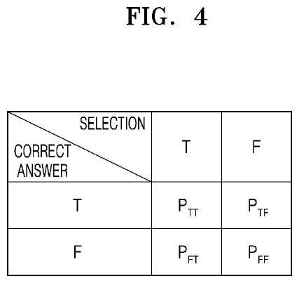

The computing device 1000 may communicate with a plurality of worker terminals 2000 and a plurality of reviewer terminals 3000, so as to provide work to the worker terminals 2000, thereby receiving task results and provide the task results to the reviewer terminals 3000, thereby receiving review results. In addition, a comprehensive review result, such as whether the task result is correct or not, may be derived based on the review results for the multiple task results received from the reviewer terminals 3000. This will be described in detail with reference to FIGS. 2 and 4.

In addition, the computing device 1000 may provide a predetermined reward to a corresponding worker for the task result performed by the worker, or may provide a predetermined reward to a corresponding reviewer for the review result performed by the reviewer. Although the computing device 1000 in FIG. 1 is illustrated as a single computing device 1000 that is not physically separated, the computing device 1000 may include a plurality of physically separated detailed computing devices. For example, the computing device 1000 may include a first detailed computing device (not shown) including configurations for providing works to the worker terminals 2000 to receive task results from the worker terminals 2000, providing the task results to the reviewer terminals 3000 to receive review results from the reviewer terminals 3000, and providing predetermined rewards to the workers and the reviewers, respectively, and a second detailed computing device (not shown) including a configuration for outputting comprehensive review result for the corresponding task results based on the received review results. In the above case, the first detailed computing device and the second detailed computing device may be physically separated, however, data may be exchanged through mutual communication. The computing device 1000 may be various types of data processing devices, such as a server, capable of performing communication with the worker terminals 2000 and the reviewer terminals 3000 and deriving the comprehensive review result according to review results of multiple reviewers.

Although not shown in FIG. 1, according to another embodiment of the present invention, the computing device 1000 may communicate with a data requestor terminal (not shown) and may receive works requiring labeling tasks requested by a data requestor through the data requestor terminal, and receive the labeled work from the computing device 1000 according to the comprehensive result outputted based on the review result on the task results for the corresponding work. In addition, the work having a type required by the data requester may be pre-stored in the computing device 1000, and the data requestor terminal may receive the work labeled for the pre-stored work from the computing device 1000.

FIG. 2 schematically shows internal configuration of the computing device for implementing the method for deriving the review result by reflecting the reliability information of the reviewer according to one embodiment of the present invention.

As shown in FIG. 2, the computing device 1000 may include a plurality of components for implementing a method for deriving review results by reflecting reliability information of the reviewer. Specifically, in order to label and review a work, the components for communicating with a plurality of worker terminals 2000 and a plurality of reviewer terminals 3000 may include a work providing unit 1010, a task result receiving unit 1020, a task result providing unit 1030, a review result receiving unit 1040, an initial reliability test providing unit 1050, and a test result receiving unit 1060.

The work providing unit 1010 provides at least one work for performing labeling to a plurality of worker terminals 2000. Each work may include at least one unit task, the worker may input task results by performing labeling for each unit task included in the provided work. In addition, the work providing unit 1010 may provide the work previously stored in the DB 1110 of the computing device 1000 or the work received from the data requestor terminal to the worker terminals 2000.

The task result receiving unit 1020 receives, from a corresponding worker terminal 2000, a task result performed by the worker with respect to the provided work. The task result may include detailed task results on the at least one unit task included in the work, or the task result may be the task result for each of the at least one unit task included in the work. In addition, the received task result may be stored in the DB 1110 of the computing device 1000.

The task result providing unit 1030 provides the task results to a plurality of reviewer terminals 3000 in order to review the task results received from the worker terminals 2000. The reviewer may input review results after performing reviews on the provided task results.

The review result receiving unit 1040 receives the review result performed by the reviewer for the provided task result, from the reviewer terminal 3000. For example, when the task result indicates a region of a car included in an image and labels the region as a car, the review result may refer to inputting whether the corresponding region is a car.

The initial reliability test providing unit 1050 requires reliability information on each reviewer in order to derive a comprehensive review result for each unit task for the review results of the reviewers. In order to derive initial reliability information corresponding to an initial value of reliability information on each reviewer, the initial reliability test providing unit 1050 provides a plurality of initial reliability tests to a plurality of reviewer terminals 3000.

The test result receiving unit 1060 receives, from a plurality of reviewer terminals 3000, test results inputted by performing a plurality of initial reliability tests provided through the initial reliability test providing unit 1050 by a plurality of reviewers. As in the above, initial reliability information may be created for each reviewer, compared to correct answers assigned to the initial reliability tests through the test results received for each reviewer.

In addition, in another embodiment of the present invention, the configuration in which the initial reliability test providing unit 1050 provides a plurality of initial reliability tests to a plurality of reviewer terminals 3000 may be included in the task result providing unit 1030. Specifically, the task result providing unit 1030 may provide a plurality of task results and a plurality of initial reliability tests together to a plurality of reviewer terminals 3000. Accordingly, the configuration, in which the test results are received from the reviewer terminals 3000 in the above-described test result receiving unit 1060, is also included in the review result receiving unit 1040, so that the review result receiving unit 1040 may receive review results and test results on the initial reliability tests, from the reviewer terminals 3000.

In addition, the computing device 1000 may further include components for deriving the comprehensive review result for each of a plurality of unit tasks, and the corresponding component may include an initial reliability information deriving unit 1070, a review result inference unit 1080, a reliability information update unit 1090, and a final comprehensive review result derivation unit 1100.

The initial reliability information deriving unit 1070 may derive initial reliability information for each reviewer, based on the test results on each reviewer received from the above-described test result receiving unit 1060 and correct answers of the initial reliability tests. The initial reliability information for each reviewer derived from the initial reliability information deriving unit 1070 may correspond to reliability information used to initially derive the first comprehensive review result on the review results of a plurality of reviewers in the review result inference unit 1080 described later.

The review result inference unit 1080 derives the first comprehensive review result for each unit task, based on the review results performed by a plurality of reviewers for each unit task and the reliability information for each reviewer. When the first comprehensive review result is derived for the first time, the review result inference unit 1080 may derive the first comprehensive review result by using the initial reliability information for each reviewer created by the initial reliability information deriving unit 1070, and then may repeatedly derive the new first comprehensive review results by using the reliability information updated in the reliability information update unit 1090.

The reliability information update unit 1090 updates the reliability information for each reviewer, based on the first comprehensive review result for each unit task derived from the review result inference unit 1080 and the review results of a plurality of reviewers for each unit task. Based on the updated reliability information and the review results performed by the reviewers, the first comprehensive review result may be derived from the review result inference unit 1080 again, and the reliability information update unit 1090 may update the reliability information again based on the new first comprehensive review result.

The final comprehensive review result derivation unit 1100 may be updated for a predetermined number of times in the reliability information update unit 1090 and derive a final comprehensive review result for each unit task based on the reliability information finally updated and the review results performed by a plurality of reviewers for each unit task. The final comprehensive review result may be a finally labeled result for the unit task.

In addition, the configuration in which the final comprehensive review result is derived in the final comprehensive review result derivation unit 1100 may be included in the review result inference unit 1080. Specifically, the review result inference unit 1080 may derive each first comprehensive review result based on each reliability information until finally updated, and may also derive the final comprehensive review result based on the finally updated reliability information.

In addition, the computing device 1000 may further include a DB 1110 in addition to the above components. The DB 1110 may store information for constructing labeled data based on crowdsourcing. Specifically, the DB 1110 may store review result inference information that includes: worker information on each worker using a worker terminal 2000 communicating with the computing device 1000, reviewer information on each reviewer using a reviewer terminal 3000, a work on which labeling is performed, a task result performed by each worker on the work, a review result performed by each reviewer for the task result, initial reliability test information for deriving initial reliability information of the reviewer, initial reliability information of each reviewer and reliability information updated by the reliability information update unit 1090, and a first comprehensive review result and a final comprehensive review result derived by the review result inference unit 1080 and the final review comprehensive result derivation unit 1110.

In addition, the internal configuration of the computing device 1000 shown in FIG. 2 is shown as only essential components in order to easily describe the present invention, and various components such as a communication unit and a control unit may be further included in addition thereto.

In addition, the computing device 1000 may be implemented as one device that is physically separated. However, according to another embodiment of the present invention, the computing device 1000 may include the above-described one or more components in a plurality of physically separated devices, and the physically separated devices may communicate with each other to perform functions of the computing device 1000.

In one embodiment of the present invention, an interface including a work may be displayed on the worker terminal 2000.

In one embodiment of the present invention, a requested object may be photographed using a camera provided in the worker terminal 2000. For example, the task result may be an image of a calendar photographed by the worker upon a request for a task of taking a picture of a calendar. Meanwhile, with respect to the above task results, the reviewer may input a review result by inputting whether the photographed image is a calendar.

In another embodiment of the present invention, an interface including a work in the form of an image may be display on the worker terminal 2000. The worker provided with the above work may input a task result by setting a region of a specific object included in the image. In this case, a specific object (such as a table) to be set as the region may be indicated in the interface. Meanwhile, for the corresponding task result, the reviewer may input a review result by inputting whether the region set in the image is the specific object, or by inputting whether the region of the specific object is set normally.

In another embodiment of the present invention, the worker provided with the work in the form of an image may input a task result by selecting specific objects included in the image. Likewise, a specific object (such as a vehicle) to be selected may be indicated in the interface. Meanwhile, for the corresponding task result, the reviewer may input a review result by inputting whether all the specific objects included in the image are selected, or by inputting whether the region of the selected specific object is set normally.

In another embodiment of the present invention, the worker provided with the work in the form of an image may input a task result by selecting an option related to the image or directly inputting information related to the image. Meanwhile, for the corresponding task result, the reviewer may input a review result by inputting whether the selected option for the image is correct, or by inputting whether the directly inputted information is appropriate.

In addition, in one embodiment of the present invention, a task may also be performed on a text-based work. Specifically, the worker provided with a work in the form of an image containing specific text may input a task result by directly inputting the text contained in the image. In addition, for the corresponding task result, the reviewer may input a review result by inputting whether the text included in the image matches the text inputted by the worker.

In another embodiment of the present invention, the worker provided with a work for at least one key word may input a task result by inputting a sentence related to the at least one key word. In addition, for the corresponding task result, the reviewer may input a review result by inputting whether the inputted sentence is properly related to the at least one key word.

In another embodiment of the present invention, the worker provided with a work in the form of a voice obtained by converting predetermined text into voice may input a task result by listening to the voice and directly inputting the corresponding voice in the form of text. In addition, for the corresponding task result, the reviewer may input a review result by inputting whether the inputted text matches the voice.

In another embodiment of the present invention, the worker provided with a work for at least one key word may input a task result by recording a sentence related to the at least one keywords in the form of voice. In addition, for the corresponding task result, the reviewer may input a review result by inputting whether the recorded voice and the at least one keyword are properly related, or whether the recording is normally conducted.

In addition, in one embodiment of the present invention, the worker provided with a work in the form of an image may input a task result by setting one or more feature points requested in the image. For example, when an image of a human face is provided as a work, the worker may input a task result by setting a plurality of feature points for ‘forehead’, ‘left eyebrow’, ‘right eyebrow’, ‘left eye’, ‘right eye’, ‘nose’, ‘left chin’, ‘lip’, ‘right chin’, and ‘chin’ in the face image.

In addition, one work may include one or more unit tasks, and the worker may input a task result for each unit task. For example, in addition to the task result for the unit task of setting the feature points as described above, the worker may input the task result for the unit task by inputting a specific age group with respect to the unit task of inputting an age group estimated from the face image. In addition, the worker may input the task result for the unit task by inputting a specific sex with respect to the unit task of inputting a sex estimated from the face image. In addition, the worker may input the task result for the unit task by inputting the objects included in the image with respect to the unit task of inputting objects included in the image.

Accordingly, one or more unit tasks may be included in one work, and the reviewer may perform a review on each task result of each unit task for the corresponding work, thereby inputting a review result for each unit task.

In one embodiment of the present invention, the worker provided with a work in the form of an image or video may, in the provided image or video (a specific frame of the video), set a region of a main object or a specific object requested as a task by inputting a plurality of points, and may input a task result by performing labeling on the set region. In addition, for the corresponding task result, the reviewer may input a review result by inputting whether the region of the object is set normally, or whether the inputted label is correct for the set region.

In addition, in addition to selecting a specific option from two options such as True or False as described above, the review result inputted by the reviewer may include various types of review results, such as selecting a specific option from three or more options, or directly inputting text or the like, by the reviewer, for the task result.

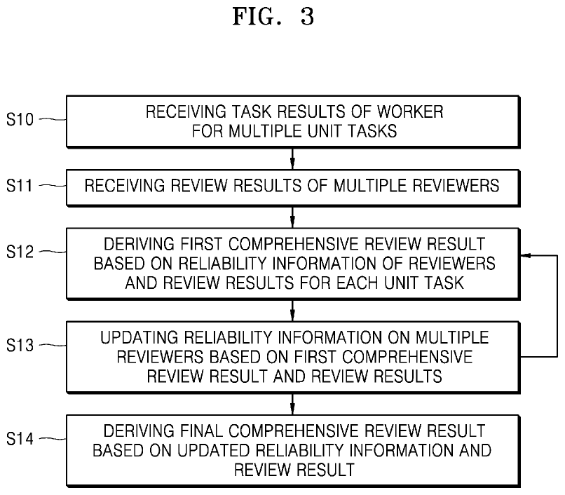

FIG. 3 schematically shows detailed processes of the method for deriving the review result by reflecting the reliability information of the reviewer according to one embodiment of the present invention.

As shown in FIG. 3, the method for deriving review results reflecting reliability information on reviewers reviewing works collected through crowdsourcing performed in the computing device 1000 having at least one memory and at least one processor includes: receiving task results of the worker for a plurality of unit tasks (S10); Receiving the review results of a plurality of reviewers for the task results of a plurality of unit tasks (S11); a review result inference step (S12) of deriving a first comprehensive review result for each of the unit tasks, based on reliability information of the reviewers and the review results of the reviewers with respect to each of the unit tasks for deriving a comprehensive review result; a reliability information update step (S13) of updating reliability information on each of the reviewers, based on the first comprehensive review result and the review results of the reviewers; and a step (S14) of deriving a final comprehensive review result for each of the unit tasks, based on the updated reliability information on each of the reviewers and the review results of the reviewers, wherein the review result inference step S12 and the reliability information update step S13 may be sequentially performed N times or more (N is a natural number greater than or equal to 1), the reliability information of the reviewers in the initial review result inference step S12 may be determined according to a preset rule, and the reliability information of the reviewers used in the M times of review result inference step S12 (M is a natural number greater than or equal to 2) may correspond to the reliability information updated in the M−1 times of reliability information update step S13.

Specifically, as described above, the worker performs a task for the provided work and inputs the task result to the worker terminal 2000, and the task result receiving unit 1020 of the computing device 1000 performs a step S10 of receiving the task result to receive a plurality of task results from a plurality of worker terminals 2000. In addition, the computing device 1000 provides the received task results to reviewer terminals 3000 of a plurality of reviewers for reviewing the task results, so as to enable the reviewers to review each task result through the reviewer terminal 3000 and input the review result.

In another embodiment of the present invention, the step S10 may be omitted, and the task result of the worker (primary worker) for a plurality of unit tasks may be provided through an external computing device such as a separate server.

In addition, the review result receiving unit 1040 of the computing device 1000 performs a step S11 of receiving the review result, so as to receive a plurality of review results for the task result from a plurality of review terminals 3000.

In another embodiment of the present invention, the step S11 of receiving the review result may refer to receiving task results of the worker performing a task including a review.

Next, the review result inference unit 1080 performs the review result inference step S12, thereby deriving a first comprehensive review result for each unit task, based on the reliability information for each of the reviewers having performed the reviews and the review result performed by each reviewer. In addition, the review result inference step S12 may be repeatedly performed, and the first comprehensive review result derived when the review result inference step S12 is initially performed derive a first comprehensive review result for each unit task, based on the reliability information for each reviewer determined according to the preset rule and the review result performed by each reviewer.

In order to derive the initial first comprehensive review result, the reliability information for each reviewer determined according to the preset rule may correspond to initial reliability information derived for each reviewer, based on test results for a plurality of initial reliability tests performed by each reviewer in the above-described initial reliability information deriving unit 1070. In addition, the first comprehensive review result derived from the review result inference step S12 may be used to update the previous reliability information for each reviewer in the reliability information update step S13 described later.

In another embodiment of the present invention, the review result inference step S12 may refer to a task result inference step of deriving the first comprehensive task result for each unit task, based on reliability information for each of a plurality of workers performing tasks including a review and a task result performed by each worker.

In the reliability information update step S13 performed by the reliability information update unit 1090, the first comprehensive review result for each unit task is compared with the review result for each of the reviewers for each unit task, so that the reliability information for each reviewer is updated so as to minimize an error value. In addition, the reliability information updated through the reliability information update step S13 may be used as reliability information for deriving a new first comprehensive review result in the review result inference step S12.

In other words, the first comprehensive review result derived in the review result inference step S12 may be used to update the previous reliability information in the reliability information update step S13, and the reliability information updated in the reliability information update step S13 may be used to derive a new first comprehensive review result in the review result inference step S12. Accordingly, the review result inference step S12 and the reliability information update step S13 may be performed one or more times sequentially. In the M-th (M is a natural number greater than or equal to 2) review result inference step S12, the M-th first comprehensive review result may be derived based on the reliability information updated in the (M−1)—the reliability information update step S13.

The above process may be repeated until the reliability information converges to a specific value or repeated for a preset number of times. Finally, when reliability information is updated, the step S14 of deriving a final comprehensive review result may be performed based on the reliability information.

According to another embodiment of the present invention, in the reliability information update step S13, the above-described first comprehensive task result for each unit task is compared with the task results for the workers for each unit task, so that reliability information for each worker may be updated to minimize an error value.

As described above, the final comprehensive review result derivation unit 1100 performs the step S14 of deriving the final comprehensive review result to derive the final comprehensive review result for each unit task based on the finally updated reliability information for each reviewer and the review results performed by the reviewers. Accordingly, the final comprehensive review result for each unit task derived in the step S14 of deriving the final comprehensive review result is may correspond to a result inferred as a correct answer for each unit task.

According to another embodiment of the present invention, the step S14 of deriving the final comprehensive review result may refer to the step of deriving the final comprehensive task result with respect to each of the unit tasks, based on reliability information on each of a plurality of workers having performed tasks including a plurality of updated reviews and the task results of the workers.

Accordingly, in the present invention, the reliability information of the reviewer, that is, the review ability of the reviewer is estimated based on the reviewer results currently performed by the reviewer, and the estimated review ability of the reviewer is used as a weight for estimating the correct answer (final comprehensive review result) of the corresponding unit task, so that high-quality learning data may be effectively established.

In other words, the present invention can more accurately estimate the correct answer of the task result, compared to the conventional method for determining a correct answer of the task result by a majority vote without consideration of a review ability of each reviewer, or estimating a correct answer of a current task result by estimating a review ability based on past review results of the reviewer.

FIG. 4 schematically shows the reliability information according to one embodiment of the present invention.

As shown in FIG. 4, the reliability information of the reviewer includes a plurality of detailed reliability information in which a plurality of values that may correspond to a review result for the task result of the unit task are determined according to the number.

Specifically, the reliability information of the reviewer may include a plurality of pieces of detailed reliability information, and the detailed reliability information and the number thereof may be determined according to a value of the review result which the reviewer can input, that is, according to the number of options which can be inputted as the review result. For example, the options which can be inputted as the review result may include various cases such as a review result (True or False) on whether the task result is performed normally, a review result (Male or Female) on whether a sex of a person included in an image is inputted normally, and a review result on whether a label and a region of an object included in the image are set normally (Labeling normal—region setting normal, labeling normal—region setting abnormal, labeling abnormal—region setting normal and labeling abnormal—region setting abnormal).

In addition, when there are 2 review result values for example as shown in FIG. 4, and a value of the review result for the task result of the unit task corresponds to True or False, the reliability information of the reviewer may include first detailed reliability information about the probability that the reviewer evaluates the task result of the unit task corresponding to an actual truth as True; second detailed reliability information on the probability that the reviewer evaluates the task result of the unit task corresponding to an actual truth as False; third detailed reliability information about the probability that the reviewer evaluates the task result of the unit task corresponding to an actual False as True; and fourth detailed reliability information on the probability that the reviewer evaluates the task result of the unit task corresponding to an actual False as False.

Specifically, the reviewer may input the review result by selecting one of the two options of True/False for the task result, and at least one detailed reliability information included in the reliability information of the corresponding reviewer may be determined according to a review result reviewed by the reviewer on the task result and a type of correct answer of the actual task result.

Referring to FIG. 4, when the review result has two options of True/False, the reliability information may include a total of four detailed reliability information. The detailed reliability information may include first detailed reliability information PTT about the probability that the reviewer evaluates the task result of the unit task, which actually corresponds to a True correct answer, as True, second detailed reliability information PTF about the probability that the reviewer evaluates the task result of the unit task, which actually corresponds to a True correct answer, as False, third detailed reliability information PFT about the probability that the reviewer evaluates the task result of the unit task, which actually corresponds to a False correct answer, as True, and fourth detailed reliability information PFF about the probability that the reviewer evaluates the task result of the unit task, which actually corresponds to a False correct answer, as False.

In addition, since the detailed reliability information corresponding to the probability that the reviewer correctly reviews the task result (True for True and False for False) corresponds to the first detailed reliability information PTT and the fourth detailed reliability information PFF, the first detailed reliability information PTT and the fourth detailed reliability information PFF may have the same value. In addition, since the detailed reliability information corresponding to the probability that the reviewer incorrectly reviews the task result (False for True and True for False) corresponds to the second detailed reliability information PTF and the third detailed reliability information PFT, the second detailed reliability information PTF and third the detailed reliability information PFT may have the same value.

In addition, the sum of the first detailed reliability information PTT and the third detailed reliability information PFT may be 1. Likewise, the sum of the second detailed reliability information PTF and the fourth detailed reliability information PFF may also be 1.

Accordingly, the reliability information for each reviewer may include at least one detailed reliability information, and the detailed reliability information may be determined according to at least one option that may correspond to the review result. Meanwhile, the reliability information for each reviewer may be used to derive the first comprehensive review result and the final comprehensive review result in the step of deriving the final review result inference step S12 and the final comprehensive review result S14, and the reliability information for each reviewer may be updated until converging to a specific value in the reliability information update step S13.

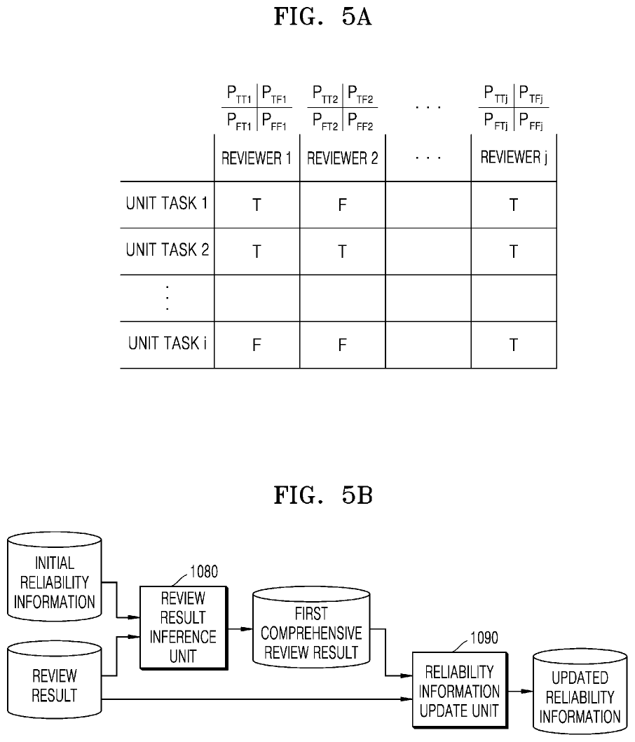

FIGS. 5A and 5B schematically show a process of updating reliability information according to review results of a plurality of reviewers for task results of a plurality of unit tasks according to one embodiment of the present invention.

FIG. 5A is a view showing review results (T or F) performed by a plurality of reviewers (reviewer 1 to reviewer j) with respect to task results of a plurality of unit tasks (unit task 1 to unit task i). FIG. 5B is a view showing a process of deriving the first comprehensive review result based on review results performed by a plurality of reviewers with respect to task results of a plurality of unit tasks and reliability information of the reviewers, and of updating reliability information according to the first comprehensive review result.

As shown in FIG. 5A, when a value of the review result for the task result of the unit task corresponds to True or False in the review result inference step S12, a first value is assigned when the value of the review result is True, and a second value is assigned when the value of the review result is False, so that the first comprehensive review result for each of a plurality of unit tasks by using the following [Equation 1].

First comprehensive task result for i-th unit task=f(Σⱼ reliability informationⱼ*task result_{i,j}) [Equation 1]

(where, task result_{i,j} is a value of a task result evaluated by the j-th worker for the i-th unit task, reliability informationⱼ is reliability information of the j-th worker, and f is a function representing a value reflecting the reliability information in the task result as an interpretable comprehensive transformation value)

Specifically, a plurality of unit tasks shown in FIG. 5A may correspond to different unit tasks, but may correspond to task results of the same type of unit task. Alternatively, a plurality of unit tasks may all correspond to the same unit task, but may correspond to task results by tasks of a plurality of different workers. Accordingly, the reliability information of the reviewer for each unit task can be equally applied.

In addition, in the review result inference step S12, the reliability information for each reviewer for each unit task and the review result for the unit task are calculated using [Equation 1], so that the first comprehensive review result may be derived for each unit task. More specifically, the first comprehensive review result for a specific unit task may correspond to a value obtained by adding, for each reviewer, all of a value (first value or second value) assigned according to the review result of the reviewer for the unit task and values of a function using the reliability information of the reviewer as a variable.

In addition, an example of function ƒ withe reliability information as a variable may also be expressed as:

$$f ( {a}_{i} , {b}_{i} ) = \frac{{a}_{i} {p}_{i}}{{a}_{i} {p}_{i} + {b}_{i} ( 1 - {p}_{i} )}$$

In the above Equation, pi is the probability that the review result for the task result of the i-th unit task is True, ai is the probability of getting the correct answer when the correct answer of the task result of the i-th unit task is True, and bi is the probability of getting the correct answer when the correct answer of the task result of the i-th unit task is False. In other words, ai and bi may correspond to reliability information.

More specifically, as example for the above [Equation 1], when a value of the review result for the task result of the unit task corresponds to True or False in the review result inference step S12, a first value is assigned when the value of the review result is True, and a second value is assigned when the value of the review result is False, so that the first comprehensive review result for each of a plurality of unit tasks by using the following [Equation 2].

First comprehensive task result for i-th unit task=f(Σⱼ reliability informationⱼ*task result_{i,j}) [Equation 2]

(where, task result_{i,j} is a value of a task result evaluated by the j-th worker for the i-th unit task, reliability information; is values of the first detailed reliability information—the third detailed reliability information of the j-th worker, or values of the fourth detailed reliability information—the second detailed reliability information, and f is a function representing a value reflecting the reliability information; in the task result as an interpretable comprehensive transformation value)

In other words, [Equation 2] may correspond to an Equation describing [Equation 1] in more detail. Preferably, the first value (when the review result is True) may correspond to 1, and the second value (when the review result is False) may correspond to −1. In addition, referring to the description in FIG. 4, the reliability information on reviewer j may include first detailed reliability information P_{TTj}, second detailed reliability information P_{TFj}, third detailed reliability information P_{FTj}, and fourth detailed reliability information P_{FFj}.

In addition, the following Equation may correspond to one embodiment of [Equation 2]

$$First comprehensive review result for i - th unit task = \frac{f ( {Σ}_{j} review {result}_{i , j} * reliability {information}_{j} )}{L}$$

(where, review result_{i,j} is a value of a review result evaluated by the j-th reviewer for the i-th unit task, reliability information j is values of the first detailed reliability information—the third detailed reliability information of the j-th reviewer, or values of the fourth detailed reliability e second detailed reliability information, and L is the total number of reviewers or L=Σⱼ reliability informationⱼ

When calculating the first comprehensive review result by using the above Equation for the task result for the first unit task (unit task 1) shown in FIG. 5A, the first comprehensive review result for unit task 1 may correspond to ((1*(P_{TT1}−P_{FT1}))+(−1*(P_{FF2}−P_{TF2}))+ . . . +(1*(P_{TTj}−P_{FTj})))/j.

In the above manner, the first comprehensive review result for each unit task may be derived based on the reliability information of the reviewers and the review result of the reviewer for each unit task.

Preferably, the first comprehensive review result may correspond to information on specific options that may correspond to the review result determined according to a reference value with respect to a predetermined value calculated through [Equation 2]. For example, the reference value may be 0. When the predetermined value calculated through [Equation 2] is 0 or more, the first comprehensive review result may correspond to True, and when the predetermined value calculated through [Equation 2] is less than 0, the first comprehensive review result may correspond to False.

In addition, when the review result inference step S12 is initially performed, the reliability information of a plurality of reviewers may derive a first comprehensive review result by using the initial reliability information derived according to a preset rule, and the initial reliability information may have the same initial value for each reviewer, or correspond to initial reliability information derived based on the test results for a plurality of initial reliability tests performed by the reviewer in the reliability information update step S13 as described above.

The above-described [Equation 1] and [Equation 2] are configured to derive the first comprehensive task result for unit task in a special case in which the task result of a task including the unit task is True or False, that is, there are two options as the task result, so as to easily describe the present invention. Further, when the task result has 3 or more options, the first comprehensive task result for the unit task may be derived through the following [Equation 3].

In the task result inference step, the following [Equation 3] is used with respect to the task result for the work including the unit task, so as to derive the first comprehensive task result for each of a plurality of unit tasks.

First comprehensive task result for i-th unit task=f(Σⱼ reliability informationⱼ*task result_{i,j}) [Equation 3]

(where, task result_{i,j} is a value of a task result evaluated by the j-th worker for the i-th unit task, reliability information is reliability information of the j-th worker, and f is a function representing a value reflecting the reliability information; in the task result as an interpretable comprehensive transformation value)

For [Equation 3], in the general case where the number of task results is 3 or more, the reliability informationⱼ signifying the reliability information of the j-th worker may be expressed as follows.

When the number of a plurality of values that may correspond to the task result for the work including the unit task is N, the reliability information of the worker may include detailed reliability information about the probability that the worker answers with the j-th value to the task result of the unit task corresponding to the actual i-th value (i, j is a natural number less than or equal to N), that is, total N*2 detailed reliability information.

In other words, for the reliability information of the worker, the number of a plurality of detailed reliability information is determined according to the number of values that may correspond to the task result, and the reliability information of the worker may be outputted based on a plurality of detailed reliability information. The worker's reliability information outputted in the above manner is used as a factor in [Equation 3] so as to finally derive the first comprehensive task result for the unit task.

Next, as shown in FIG. 5B in the reliability information update step S13, the reliability information may be updated to minimize the error between the first comprehensive review result for each of the unit tasks derived through [Equation 3], and the review result for each of the unit tasks for each of the reviewers in the review result inference step S12.

Specifically, in the reliability information update step S13, the reliability information may be updated to minimize the error between the first comprehensive review result for each unit task derived through [Equation 1] to [Equation 3], and the review result for each reviewer in the review result inference step S12 as described above. In other words, in the reliability information update step S13, the reviewers' reliability information is derived and updated for minimizing the comprehensive error between the first comprehensive review result for each of the unit tasks derived by the review result inference step S12 and the review result of each of the reviewers, thereby calculating a function or probability model that uses the total number of reviewers as a dimension or variable, so that the reliability information of the reviewer may be updated.

Accordingly, as one embodiment for updating the reliability information of the reviewer, a probability model p(z, q) for a correct answer z of each unit task corresponding to a latent variable and a reliability or review ability q of the reviewer may be created, and the probability model may be used, so that the reliability information of the reviewer may be updated.

More specifically, the probability model p (z, q) may be expressed as an observable value as in [Equation 4] described below.

$$p ( z , q \vert L , θ ) ∝ {\prod }_{j ∈ [ M ]} p ( {q}_{j} \vert θ ) {\prod }_{i ∈ {N}_{j}} p ( {L}_{i j} \vert {z}_{i} , {q}_{j} ) = {\prod }_{j ∈ [ M ]} p ( {q}_{j} \vert θ ) {{q}_{j}^{{c}_{j}} ( 1 - {q}_{j} )}^{{γ}_{j} - {c}_{j}} \qquad [ Equation 4 ]$$

In other words, the probability model when observed data (review result) L and a parameter θ for the model are given is proportional to the product of p(qⱼ|θ) and p (Lᵢⱼ|zᵢ, qⱼ) corresponding to the observable value (j is the j-th reviewer, i is the i-th unit task). When a latent variable for maximizing a probability value of the probability model with respect to [Equation 3] is calculated, the reliability information of the reviewer may be outputted.

Preferably, an expected value of the latent variable may be calculated (E-step) as in [Equation 5] with respect to the above-mentioned [Equation 4], and an expectation maximization (EM) algorithm, which estimates (M-step) the reliability information on a reviewer using the calculated expected value, may be used, so that reliability information for each reviewer may be updated.

$$E - step : {μ}_{i} ( {z}_{i} ) ∝ {\prod }_{j ∈ {M}_{i}} {{\hat{q}}^{{δ}_{i j}} ( 1 - {\hat{q}}_{j} )}^{1 - {δ}_{i j}} , \qquad [ Equation 5 ]$$

$$M - step : {\hat{q}}_{j} = \frac{{Σ}_{i ∈ {N}_{j}} {μ}_{i} ( {L}_{i j} ) + α - 1}{\vert {N}_{j} \vert + α + β - 2}$$

The EM algorithm may use the reliability information estimated in the t-th cycle to calculate the expected value in an E-step of the (t+1)-th cycle, and the expected value calculated in the E-step of the (t+1)-th cycle may be used to estimate reliability information in the M-step of the (t+1)-th cycle, so that the E-step and the M-step may be repeatedly performed until the estimated value of reliability information converges to a specific value.

in another embodiment of the present invention, the reliability information of the reviewer may be updated by using a belief propagation algorithm for estimating a latent variable, which integrates (marginalizes) the above-mentioned [Equation 3] withe reliability q by using a graphic model to maximize a probability value of the probability model. In another embodiment of the present invention, review results of reviewers may be set as a matrix, and a Spectral Method may be used for the matrix, so that the reliability of each reviewer and the final comprehensive review result may be derived.

In addition, the reliability information updated in the reliability information update step S13 of the t-th cycle may be used to derive the first comprehensive review result in the review result inference step S12 of the (t+1)-th cycle, and the first comprehensive review result derived from the review result inference step S12 of the (t+1)-th cycle may be used to update the reliability information in the reliability information update step S13 of the (t+1) cycle. The repeated process of the review result inference step S12 and the reliability information update step S13 may be repeated until the reliability information of the reviewer converges to a specific value or may be repeated by a predetermined number of times.

The reliability information finally updated through the above process may be used to derive the final comprehensive review result for a plurality of unit tasks in the step S14 of deriving the final comprehensive review result. In the step S14 of deriving the final comprehensive review result, the final comprehensive review result for the unit task may be derived by using [Equation 1] or [Equation 2] in the same manner as the review result inference step S12.

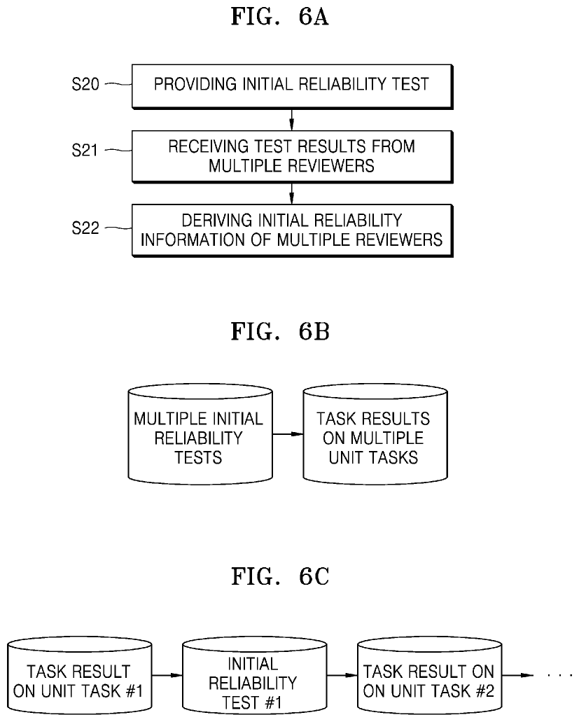

FIGS. 6A, 6B and 6C schematically show a process of deriving initial reliability information on a plurality of reviewers by receiving test results on a plurality of initial reliability tests of a plurality of reviewers according to one embodiment of the present invention.

As shown in FIG. 6A, the method for deriving a review result further includes: receiving test results of a plurality of reviewers for a plurality of initial reliability tests (S21); and an initial reliability information deriving step (S22) of deriving initial reliability information of the reviewers, based on the test results of the reviewers, wherein, in the review result inference step S12, the first comprehensive review result for each of a plurality of unit tasks may be derived based on the initial reliability information for each of the reviewers and the review results of the reviewers, at the time of initial execution.

Specifically, the initial reliability test providing unit 1050 of the computing device 1000 provides (S20) a plurality of initial reliability tests to reviewer terminals 3000 of a plurality of reviewers reviewing the task result, and each reviewer performs a test for a plurality of initial reliability tests through the corresponding reviewer terminal 3000 and inputs the test result. In addition, the test result receiving unit 1060 performs a step (S21) of receiving the test results inputted by each reviewer from the reviewer terminals 3000. Finally, the initial reliability information deriving unit 1070 derives (S22) initial reliability information for each reviewer based on the received test results for each reviewer. Accordingly, the initial reliability information for each reviewer derived from the initial reliability tests may be used as reliability information for deriving the first comprehensive review result when the review result inference step S12 is initially performed.

The content of the initial reliability test may have a separate test content different from the review on the task result in order to derive the initial reliability, however, may preferably correspond to the content similar to that of the review by the reviewer on the task result.

In addition, as one embodiment of a method for deriving initial reliability information based on test results for a plurality of initial reliability tests, each initial reliability test has a preassigned correct answer, and the test result inputted by the reviewer is compared with the correct answer for the initial reliability test, so that the initial reliability information of the reviewer may be derived.

In another embodiment of the present invention, each initial reliability test has a correct answer and a difficulty level that are preassigned, and the weight according to the difficulty level is given instead of setting each initial reliability test to the same weight, so that more accurate initial reliability information may be derived.

In addition, according to the present invention, when the initial reliability test is provided to the reviewer, the initial reliability test may be clearly stated on the reviewer terminal 3000 so that the reviewer can recognize that the process is a separate test rather than an actual review, or the initial reliability test may not be clearly stated, so that the reviewer cannot distinguish whether the process is the actual review or the initial reliability test, thereby deriving more effective initial reliability information.

In addition, according to the present invention, various methods may exist to provide the initial reliability test to the reviewer reviewing the task results, and FIGS. 6B and 6C show embodiments of the above method.

In FIG. 6B, the reviewer is allowed to perform an initial reliability test before performing a review on task results of a plurality of unit tasks. When the initial reliability test is performed in the above manner before the actual review, the reviewer performs the test in a state of high concentration, so that the initial reliability may be derived relatively higher than the reliability in the actual review process.

In the above case, it may take longer time to finally update the reliability information, or computing resources for calculating the reliability information may be required more.

Accordingly, as shown in FIG. 6C, in the step of receiving the test result, test results for a plurality of initial reliability tests performed between the task results of the unit tasks on which a plurality of reviewers perform reviews are received in order to efficiently derive the initial reliability information.

Specifically, the initial reliability test provided to the reviewer may be arranged and provided between the task results of the unit task to be actually reviewed, or some of the initial reliability tests may be provided before the actual review, and the remaining initial reliability tests may be arranged and provided between the task results of the unit task to be actually reviewed.

When the reviewer performs the review through the above configuration, the initial reliability information may be derived while considering the deterioration of concentration or condition, so that the time required for finally updating the reliability information from initial reliability information can be shortened, or the amount of computing resources used to calculate the reliability information can be reduced.

In addition, according to the present invention as shown in FIG. 6C, it is not limited to the configuration of providing one initial reliability test between a task result of the unit task and a task result of another unit task, and it may even include the configuration of providing a plurality of initial reliability tests between a task result of the unit task and a task result of another unit task.

2. Method for Automatically Selecting Sample Tasks and Obtaining Correct Answers for Worker Competency Tests without Expert Response Through Crowdsourcing

As described above, in the present invention, task results may be derived by reflecting the reliability information of the worker who processes the tasks collected through crowdsourcing.

Hereinafter, the method for automatically selecting sample tasks and obtaining correct answers for worker expert response through competency tests without crowdsourcing will be described in detail.

The method for deriving the reliability information of each worker performed by the initial task processing unit of the present invention described later may be implemented through the above-mentioned method of deriving task results by reflecting the reliability information of workers who process works collected through crowdsourcing.

In addition, the systems and the computing device described later may be a computing device including at least one component for performing the method for deriving task results by reflecting reliability information of workers through crowdsourcing processing works collected as described above. In addition, it may further include at least one component for performing the method for automatically selecting sample tasks and obtaining correct answers for worker competency tests without expert response. The expert of the present invention may refer to a reviewer who reviews task results performed by a worker for a unit task.

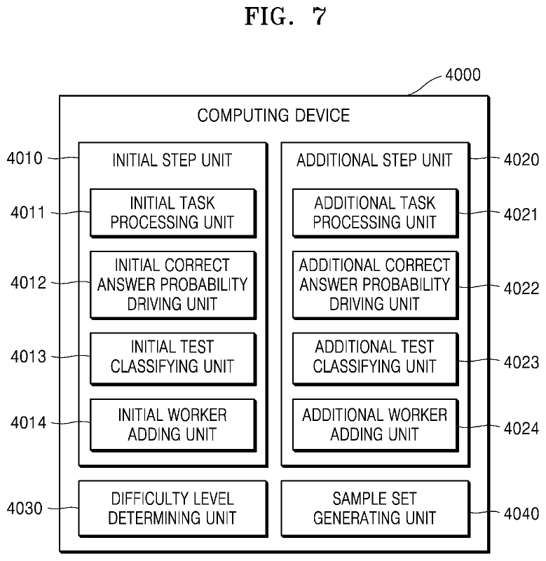

FIG. 7 schematically shows the internal configuration of a computing device for implementing method for automatically selecting a sample task for a worker competency test and obtaining a correct answer thereof according to one embodiment of the present invention.

As shown in FIG. 7, the computing device 4000 may include multiple components for implementing the method for selecting sample tasks and obtaining correct answers for worker competency tests without expert response.

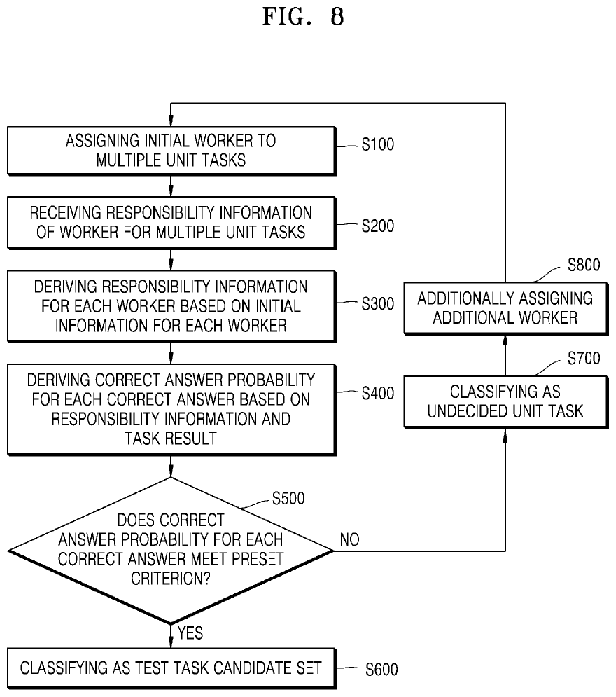

Specifically, the at least one component for deriving task results by reflecting reliability information of workers processing works collected through crowdsourcing as mentioned in FIG. 2 may be included in an initial step unit 4010 and an additional step unit 4020 of FIG. 8, and may additionally include at least one component for performing the method for automatically selecting sample tasks and obtaining correct answers for worker competency tests without expert response.

Preferably, the computing device 4000 of FIG. 7 may include an initial step unit 4010, an additional step unit 4020, a sample difficulty level determining unit 4030, and a sample set generating unit 4040, the initial step unit 4010 may further include an initial work processing unit 4011, an initial correct answer probability deriving unit 4012, an initial test classifying unit 4013 and an initial worker adding unit 4014, and the additional step unit 4020 of the computing device 4000 may further include an additional task processing unit an additional correct answer 4021, probability deriving unit 4022, an additional test classifying unit 4023 and an additional worker adding unit 4024.

In the initial processing step, reliability information on each of the initial multiple workers may be repeatedly updated until error values of the comprehensive task results of the initial multiple workers converges to a specific value.

Specifically, in the initial task processing step performed by the initial task processing unit 4011 of the initial step unit 4010, reliability information for each of multiple workers is outputted based on the preset initial reliability information on each of multiple workers and a task result on each of multiple unit tasks, which may be the same as the configuration for outputting the reliability information through the above-described task result providing unit 1020 and initial reliability information deriving unit 1070. In addition, the task results and the initial reliability information of multiple workers may be included in the initial information.

In the initial correct answer probability deriving step performed by the initial correct answer probability deriving unit 4012 of the initial step unit 4010, the correct answer probability for each answer is derived based on the reliability information and the task result of each of the initial multiple workers received by the initial task processing unit 4011.

In the initial test classifying step performed by the initial test classifying unit 4013 of the initial step unit 4010, at least one unit task that meets the preset criterion is classified into an initial test candidate set, based on the correct answer probability for each answer received from the initial correct answer probability deriving unit 4012.

In the initial worker adding step performed by the initial worker adding unit 4014 of the initial step unit 4010, at least one unit task that does not meet the preset criterion is classified into an undecided task and an additional worker is assigned, based on the correct answer probability for each answer received from the initial correct answer probability deriving unit 4012.

In the additional task processing step performed by the additional task processing unit 4021 of the additional step unit 4020, the reliability information is updated, based on the task result for at least one unit task in which a rework is performed by the initial multiple workers and the additional worker assigned by the initial worker adding unit 4014 of the initial step unit 4010.

In the additional correct answer probability deriving step performed by the additional correct answer probability deriving unit 4022 of the additional step unit 4020, the updated correct answer probability for each answer is derived based on the reliability information and the task result updated in the additional task processing unit 4021. As in the above, the correct answer probability for each answer may be derived by reflecting the task results and reliability information updated by the initial multiple workers and the additional worker.

In the additional test classifying step performed by the additional test classifying unit 4023 of the additional step unit 4020, at least one undecided task that meets the preset criterion is classified into a test task candidate set, based on the updated correct answer probability received from the additional correct probability deriving unit 4022.

In the additional worker adding step performed by the additional worker adding unit 4024 of the adding step unit 4020, at least one undecided task that does not meet the preset criterion is classified into the undecided task again based on the updated correct answer probability received from the additional correct probability deriving unit 4022, and an additional worker is added again.

multiple steps performed by the additional step unit 4020 may be repeated N times or more (N is a natural number equal to or greater than 2), until a sample task for at least one unit task and a correct answer thereof is obtained. Specifically, it may be repeatedly performed until the difficulty level for at least one unit task is set and the number of remaining undecided task meets the preset criterion. In addition, the sample difficulty level determining unit 4030 described later may be included in the additional step unit 4020 to perform the sample difficulty level determining step, or may perform the sample difficulty level determining step in a separate component distinguished from the additional step unit 4020.

In addition, the sample difficulty level determining unit 4030 performs the sample difficulty level determining step of calculating the difficulty level of a unit task based on the number of times of performing the task by the initial step unit 4010 and the additional step unit 4020, and the sample set generating unit 4040 performs the sample set generating step of receiving a randomly assigned test task candidate set having determined a difficulty level to determine a sample set.

In addition, the internal configuration of the computing device 4000 shown in FIG. 7 is shown as only essential components in order to easily describe the present invention. Besides, various components may be further included such as a communication unit, a control unit, and a DB in which information for constructing labeled data is stored.

FIG. 8 schematically shows detailed processes of an initial step of classifying multiple unit tasks into a test task candidate set based on the correct answer probability for each answer according to one embodiment of the present invention.

As shown in FIG. 8, the present invention provides a method for automatically deriving a test task labeled with a correct answer and a difficulty level of the task through crowdsourcing performed on a computing device having at least one processor and at least one memory includes: an initial step including: a task result receiving step of receiving task results of initial multiple workers on multiple unit tasks; an initial task processing step of deriving a comprehensive task result of each unit task based on initial information including the task results of the initial multiple workers, and deriving reliability information on each of the initial multiple workers based on some or all of the comprehensive task result and the initial information; an initial correct answer probability deriving step of deriving a correct answer probability for each answer for each of multiple unit tasks based on the reliability information on each of the initial multiple workers determined in the initial task processing step and the task results of the initial multiple workers; an initial test classifying step of classifying at least one unit task, in which the correct answer probability for each answer meets a preset criterion among multiple unit tasks, into a test task candidate set; and an initial worker adding step of assigning an undecided task, which includes at least one unit task in which the correct answer probability for each answer does not meet the preset criterion among multiple unit tasks, to at least one additional worker; and an additional step of receiving a task result by the additional worker on the undecided task, classifying a part of the undecided task into a test task candidate set, and classifying another part of the undecided tasks into the undecided task again.

Specifically, the methods described with reference to FIGS. 3 to 7 may be used for the methods S100, S200 and S300 for determining the reliability in the initial task processing unit 4011 of the initial step unit 4010. The duplicate description thereof will be omitted.

Next, the initial correct answer probability deriving unit 4012 performs a step S400 of deriving the correct answer probability for each answer for each of multiple unit tasks, based on the reliability information of each of the initial multiple workers and the task results of the initial multiple workers. Specifically, the correct answer probability for each answer is the probability with the label given by the worker for each unit task is the correct answer and may be expressed as a probability variable and a probability vector. Preferably, the correct answer probability for each answer may be expressed as a random vector having a specific value between 0 and 1.

The initial test classifying unit 4013 performs an initial test classifying step S600 of classifying at least one unit task into a test task candidate set based on the correct answer probability for each answer. Specifically, in the step S500 of classifying at least one unit task into a test task candidate set, statistics of the sample may include the sum of random samples, sample mean, sample variance, and sample maximum and minimum values. In addition, cross-analysis may be conducted based on multiple statistics, to ensure the reliability of the initial test classifying step S600 of classifying at least one unit task into a test task candidate set. Preferably, at least one unit task, in which the difference of correct answer probability for each answer is less than a threshold value which is very small, and there is no correct answer probability for at least one answer exceeding a specific value, may be classified into a test task candidate set.

The initial worker adding unit 4014 performs a step S700 of classifying at least one unit task, in which the correct answer probability for each answer does not meet the preset criterion, into an undecided task and an initial worker adding step S800 of assigning the undecided task to at least one additional worker. Specifically, at least one unit task when the statistics of the sample, such as the sum of random samples, the sample mean, the sample variance, and the maximum and minimum values of the sample, do not meet at least one or preset criterion may be classified into the undecided task, and at least one additional worker may be assigned. Preferably, at least one unit task in which the difference in the correct answer probability for each answer exceeds a very small threshold value or exceeds a specific value, or at least one unit task in which the correct answer probability for each answer exists may be classified into the undecided task.

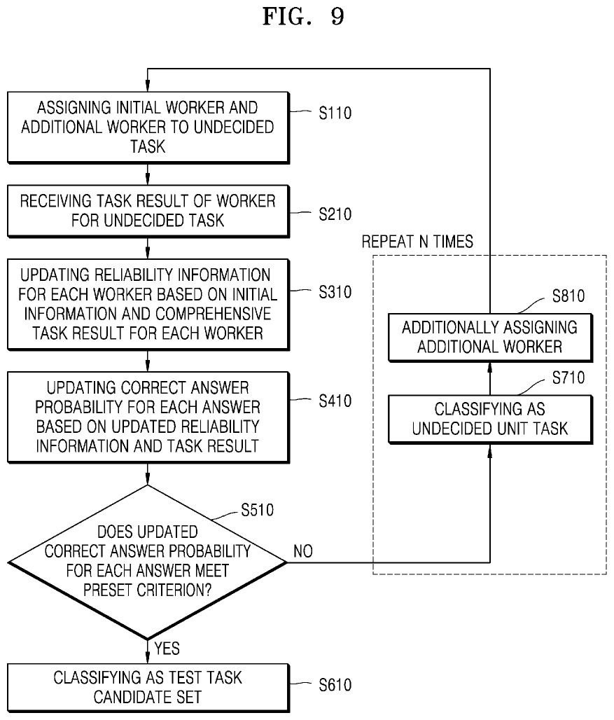

FIG. 9 schematically shows detailed processes of an additional step of classifying multiple undecided tasks into a test task candidate set according to the updated correct answer probabilities for each answer according to one embodiment of the present invention.

As shown in FIG. 9, the additional step may include: an additional task result receiving step of receiving a task result by at least one additional worker for at least one undecided task; an additional task processing step of deriving the comprehensive task result of each undecided task based on the initial information including the task results by the initial multiple workers and the additional worker with respect to the at least one undecided task, and deriving reliability information on each of the initial multiple workers and the at least one additional worker based on some or all of the comprehensive task result and the initial information; an additional correct answer probability deriving step of deriving a correct answer probability for each answer for each of multiple undecided tasks, based on the reliability information on each of the initial multiple workers and the at least one additional worker determined in the additional task processing step, and the task results by the initial multiple workers and the at least one additional worker; an additional test classifying step of classifying at least one undecided task, in which the correct answer probability for each answer meets a preset criterion among multiple undecided tasks, into a test task candidate set; and an additional worker adding step of reassigning at least one undecided tasks, in which the correct answer probability for each answer does not meet the preset criteria among multiple undecided tasks, to the at least one additional worker.

Specifically, the additional task processing unit 4021 of the additional step unit 4020 performs additional task processing steps S110, S210 and S310 for updating the reliability information, based on the basic information including the task results of the initial multiple workers and the additional worker assigned to the undecided task in the initial step. Preferably, the step of updating the reliability based on the initial information and the task of the initial multiple of workers and the additional worker by the additional task processing unit 4021 may be the same as the method S100, S200 and S300 of determining the reliability by the initial task processing unit 4011 of the initial step unit 4010.

The additional correct answer probability deriving unit 4022 performs a step S410 of updating the correct answers probability for each answer with respect to each of multiple undecided tasks, based on the reliability information and the task result for the at least one undecided task updated in the additional task processing step.

The additional test classifying unit 4023 and the additional worker adding unit 4024 repeatedly perform a step of classifying at least at least one unit task into the test task candidate set (S610) or classifying into the undecided task (S710) and additionally assigning additional workers (S810), depending on whether the at least one unit task meet all of the preset criteria (S500) based on the correct answer probability for each answer updated by a plurality of initial workers and additional workers.

Specifically, the at least one unit task having updated reliability and correct answer probability for each answer is reassigned to the same components as the initial test task candidate set classifying unit and the undecided task classifying unit of the initial step unit 4010, so as to determine whether the unit task meets the preset criterion. In addition, in another embodiment of the present invention, the at least one unit task having updated reliability and correct answer probability for each answer is assigned to the test task candidate set classifying unit and the undecided task classifying unit having separate components distinguished from the initial step unit 4010, so as to determine whether the unit task meets the preset criterion.

Meanwhile, the additional step unit 4020 may be repeated two or more times until automatically deriving a test task labeled with the correct answer and a difficulty level for at least one unit task.

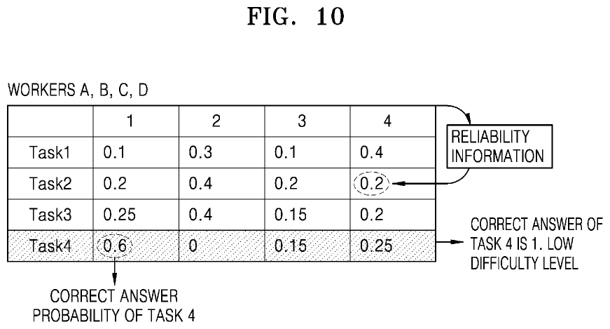

FIG. 10 schematically shows correct answer probability for each worker, unit task, and answer according to one embodiment of the present invention.

As shown in FIG. 10, the correct answer probability for each answer, which is the probability that the response of at least one worker to at least one unit task is a correct answer, may be expressed as a probability vector. Specifically, the correct answer probability for each answer may be expressed as a probability vector having the probability with a value ranging from 0 to 1 in which the response to each unit task is a correct answer, based on the reliability information and task results of multiple workers for each unit task. In addition, as shown in FIG. 10, the sum of the correct answer probabilities for each workers' answer for each unit task converges to 1.

In addition, the criterion for classifying the test task candidate set or undecided task based on the correct answer probability for each answer for each unit task may be the sum of random samples, sample mean, sample variance, and sample maximum and minimum values, which are sample statistics for a probability vector. Specifically, in one embodiment of the present invention, the at least one unit task may be classified into the test task candidate set and the undecided task depending on whether at least one of the correct answer probabilities for each answer exceeds the first threshold value, and whether the difference value between the correct answer probabilities for multiple answers exceeds the second threshold value.

Specifically, unit task #4 in which at least one of the correct answer probabilities for each answer for each worker shown in FIG. 10 exceeds the first threshold value (0.6 in this example) and the difference in the correct answer probability for each answer exceeds the second threshold value (0.2 in this example) may be classified into the test task candidate set, so that the correct answer and correct answer probability of unit task #4 classified into the test task candidate set (in this example, correct answer 1 and correct answer probability 0.6) may be derived. In addition, in the initial step, the lowest difficulty level (low difficulty level in this example) may be given to unit task #4 classified as a test task candidate set.

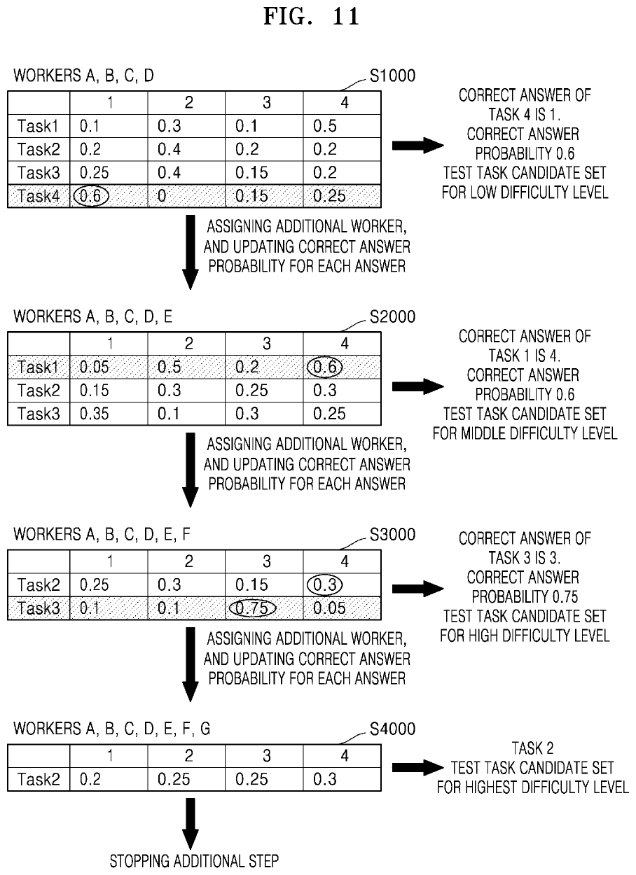

Next, unit tasks #1, 2 and 3 that do not meet any of the preset criteria may be classified into undecided tasks, and additional steps may be repeated. The process of adding additional workers and reclassifying unit tasks in the additional step will be described later with reference to FIG. 11.

In addition, the correct answer probability for each answer may be derived by reflecting reliability information of each worker. For example, the correct answer probability for a fourth answer of unit task #2 of FIG. 10 is a value derived by reflecting the reliability information of the worker. Likewise, correct answer probabilities for answers for all unit tasks (unit tasks #1, 2, 3, 4) not shown are also derived by reflecting the reliability information of the workers (workers A, B, C, D).

In addition, reliability information may be determined by the comprehensive task result and the initial information for each worker as described above, and may be updated as the additional steps are repeatedly performed.

FIG. 11 schematically shows a process of calculating a difficulty level based on the correct answer probability for each answer and classifying the test task candidate set according to one embodiment of the present invention

It shows the process of classifying each unit task calculated in the initial step and the additional step into the test task candidate set and the undecided task depending on whether the correct answer probability for each answer meets the preset criterion, and setting a difficulty level for each unit task. Specifically, S1000 shows the correct answer probabilities for answers in which the at least one worker's responses is a correct answer, based on the reliability information and the task results of the initial multiple workers for at least one unit task performed in the initial step as described above in FIG. 10. As described above, unit task #4 in which at least one of the correct answer probabilities for each answer for each worker exceeds the first threshold value (0.6 in this example) and the difference in the correct answer probability for each answer exceeds the second threshold value (0.2 in this example) may be classified into the test task candidate set, the correct answer and the correct answer probability may be derived and the corresponding a difficulty level may be assigned. In S1000 as an embodiment of the present invention, unit task #4 of task results performed by 4 workers (workers A, B, C, D) is classified into the test work candidate set and 1 as the correct answer and 0.6 as the correct answer probability is derived for unit task #4, so that low difficulty level, which is the lowest difficulty level, may be applied. In addition, the correct answer probability for each answer is determined by reflecting the reliability information of each worker as described above, and the correct answer probability and reliability information for each answer may be updated as the additional step is repeatedly performed.

In addition, unit tasks #1, 2, 3 that do not meet any of the preset criteria may be classified into undecided tasks, and the additional steps may be performed by assigning additional workers. S2000 shows answer the correct probabilities for answers updated by the initial multiple workers and the additional workers. the task result and the reliability information may be updated by assigning an additional worker E to unit tasks #1, 2 and 3 classified into the undecided tasks in S1000. In addition, unit task #1, in which the correct answer probability updated by the initial multiple workers and the at least one additional worker meets the above-mentioned preset criterion, may be classified into the test task candidate set, and 4 as the correct answer and 0.6 as the correct answer probability are derived, so that a difficulty level (middle difficulty level in this example) higher than that of the test task candidate set classified in S1000 may be applied. In addition, as described above, additional steps, in which unit tasks #2 and 3 having the correct answer probability for each updated answer that does not meet the preset criterion are again classified into undecided tasks and the additional worker is assigned, may be repeated.

Likewise, in S3000, an additional worker may be assigned to the at least one unit task classified into the undecided task in S2000, and the additional step of updating the correct answer probability for each answer based on the updated task result and the reliability information may be repeated, so that unit task #3 is classified into the test task candidate set, and 3 as the correct answer and 0.75 as the correct answer probability of unit task #3 are derived, thereby applying a difficulty level (high a difficulty level in this example) higher than that of the test task candidate set classified in S2000.

S4000 performs a step of applying the highest high difficulty leveler than that of S3000 to unit task #2, which is at least one unit task exceeding the preset maximum number of performing the task, and a step of stopping the additional step. Specifically, in one embodiment of the present invention, unit task #2, which is an undecided task when the number of times of performing the task exceeds a preset number of times and the number of undecided tasks is less than a predetermined value, is classified into the highest difficulty level task, and the additional step is stopped, so that resources (such as number of workers, time and cost) inputted for classifying unit tasks having a difficulty level set excessively high may be saved.

In addition, the criterion for classifying the at least one unit task into the test task candidate set or the undecided task may include various statistical analysis methods capable of analyzing sample statistics in addition to the sum of random samples, sample mean, sample variance, and sample maximum and minimum values, and the reliability of the method for selecting the sample task and obtaining the correct answer may be ensured by conducting cross-validation on at least one unit task with multiple statistical analysis methods.

In addition, the number of times of performing the task in the additional step and the number of additional workers assigned in the additional step are not fixed to a specific number of times or a specific number of people as described above, and any value for performing a method for automatically deriving a test task labeled with the correct answer and a difficulty level of the task according to the present invention may be applicable.

In addition, in one embodiment of the present invention, the step performs that the undecided task, when the number of times of performing the task exceeds the preset number and the number of undecided tasks is less than the predetermined value, is classified as the highest difficulty level task and the additional step is stopped. However, in another embodiment of the present invention, the additional step may be repeated until the difficulty levels are set for all unit tasks without performing the step of stopping the above-mentioned additional step. Alternatively, the unit task exceeding the maximum number of times of performing task may not classified as the test task candidate set but classified as a separate unit task for which the difficulty level is not determined.

As described above, the criterion for classifying at least one unit task into the test task candidate set and the undecided task, or the criterion for determining a difficulty level of the at least one unit task may be variously modified and deformed within the scope that meets the manager's purpose and efficiently utilizes input resources.

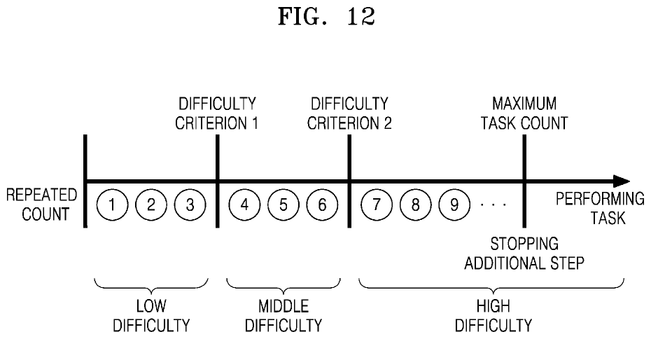

FIG. 12 schematically shows a process of setting task a difficulty level based on the number of times of performing a task according to one embodiment of the present invention.

As shown in FIG. 12, the method for automatically deriving a test task labeled with a correct answer and a difficulty level of the task further includes a sample difficulty level determining step. In the sample difficulty level determining step, a difficulty level of the unit task may be determined based on the number of times of performing the task for each of the at least one unit task included in the test task candidate set. In addition, in the sample difficulty level determining step, the difficulty level of the unit task may be set to be higher as the number of times of performing the task is increased, and may be repeatedly performed N times (N is a natural number equal to or greater than 2) until the number of remaining undecided tasks meets the preset criterion.

Specifically, the test task candidate set may be classified into a difficulty level that meets a preset a difficulty level criterion and a maximum number of times of tasks, based on the number of times of performing task in which the process of updating the task results and reliability for each unit task is performed. As shown in FIG. 12, in one embodiment of the present invention, the low difficulty level is applied to the test task candidate set in which the number of times of performing the task until at least one unit task is determined as the test task candidate set is 1 or less as the difficulty level criterion. In addition, the middle high difficulty leveler than the low difficulty level is applied to the test task candidate set in which the number of times of performing the task until at least one unit task is determined as the test task candidate set exceeds 1 as the difficulty level criterion and 2 or less as the difficulty level criterion In addition, the high difficulty level may be applied to the test task candidate set in which the number of times of performing the task until at least one unit task is determined as the test task candidate set exceeds the difficulty level criterion 2 or exceeds the maximum number of times of tasks, and the additional steps may be stopped.

In another embodiment of the present invention, the additional step may be repeated without performing the step of stopping the above-mentioned additional step until the difficulty levels are set for all unit tasks, and the unit task exceeding the maximum number of times of performing task may not classified as the test task candidate set and classified as a separate unit task for which the difficulty level is not determined. As described above, the step of determining the difficulty level of at least one unit task based on the number of times of performing the task may be variously modified and deformed within the scope that meets the manager's purpose and efficiently utilizes input resources.

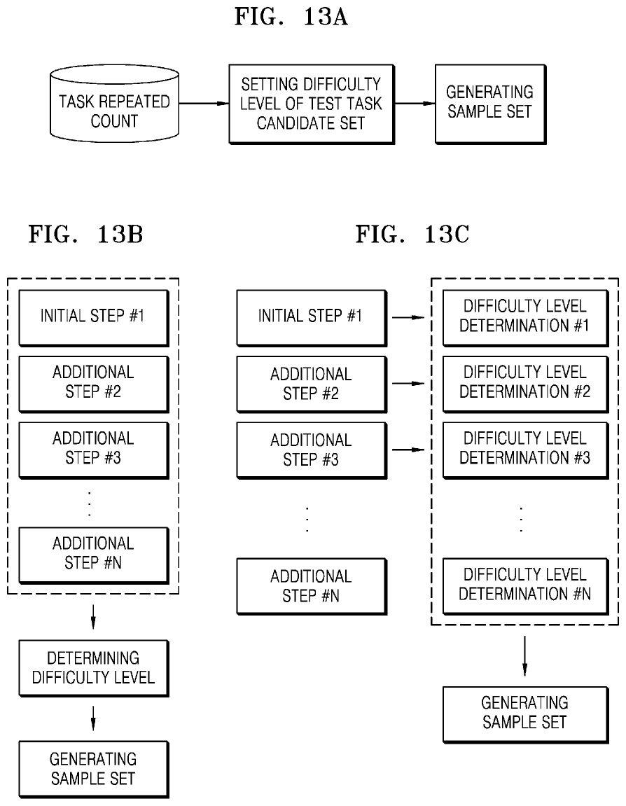

FIGS. 13A, 13B and 13C schematically show a process of setting task a difficulty level and generating a sample set based on the number of times of performing a task according to one embodiment of the present invention.

As shown in FIG. 13, each of the at least one unit task included in the test task candidate set is labeled with corresponding a difficulty level information. The method for automatically deriving a test task labeled with a correct answer and a difficulty level of the task further includes a sample set generating step, wherein a sample set generated in the sample set generating step includes at least two sub-sample sets having different difficulties. In the sample set generating step, some or all of the at least one unit task included in the test task candidate set may be assigned to a corresponding sub-sample set based on the difficulty level information.

Specifically, FIG. 13A is a view showing the process of setting the task a difficulty level for the test task candidate set determined in the initial step and the additional step based on the number of times of performing the task, and generating a sample set for each a difficulty level according to one embodiment of the present invention. FIG. 13B is a view showing the process of determining the corresponding a difficulty level for each test task candidate set and generating the sample set, after both the initial and additional steps are performed. FIG. 13C is a view showing the process of determining the corresponding a difficulty level for each test task candidate set and generating the sample set, whenever the initial or additional step is performed.

As shown in FIG. 13A, based on the number of times of performing the process of updating the task result and reliability for each of at least one unit task in the initial step unit 4010 and the additional step unit 4020, the sample difficulty level determining unit 4030 and the sample set generating unit 4040 perform the sample difficulty level determining step of calculating the difficulty level of a unit task, and the sample set generating step of automatically deriving a test task labeled with the correct answer and a difficulty level of the task.

Specifically, the number of times of performing the process of updating the task results and reliability for each of at least one unit task may be determined based on the number of times of tasks performed in the initial step and the additional step to which additional workers are assigned.

Preferably, the lowest level of a difficulty level may be applied to at least one unit task classified as the test task candidate set upon only the initially performed task, and the difficulty level of the corresponding unit task may be applied higher as the number of times of performing the task is increased. In addition, the maximum number of times of performing the above additional step may be set in advance, so that the additional step may be stopped for the unit task exceeding the maximum number of times and the highest difficulty level may be assigned. Specifically, all of remaining undecided tasks in which an undecided task when the number of times of performing the task exceeds a specific number of times and the number of undecided tasks remains until a predetermined value are classified as the highest difficulty level task and the additional step is stop, so that resources (such as number of workers, time and cost) inputted for classifying unit tasks having a difficulty level set excessively high may be saved, so as to efficiently select a sample task for the worker capability test and derive the correct answer.

In addition, in another embodiment of the present invention, the number of times of performing the process of updating the task results and reliability for each of at least one unit task may be the total number of workers including the initial multiple workers and the additional workers. Specifically, the number of times of performing the process of updating the task results and reliability for each of at least one unit task may be determined based on the number of initial multiple workers assigned in the initial step and the number of additional workers assigned in the additional step. Preferably, the lowest difficulty level is applied to at least one unit task classified as test task candidate sets upon only the initial multiple workers, and the difficulty level of the corresponding unit task may be applied higher as the number of workers assigned to the unit task is increased. In addition, the maximum number of workers for the above additional step may be set in advance, and the additional step may be stopped for the unit task exceeding the maximum number of workers and the highest difficulty level may be assigned.

The sample set generating unit 4040 performs the sample set generating step of receiving a randomly assigned test task candidate set having determined a difficulty level to determine a sample set. Specifically, in the sample set generating step, m sample sets (m is a natural number greater than or equal to 1) may be generated according to the ratio set for each a difficulty level section. Preferably, a randomly assigned sample set may be generated for each a difficulty level section based on the manager's purpose or the worker's work competence to be evaluated, the sample set may be variously modified and deformed within the range capable of exerting the effects to evaluate the worker and determine the accuracy of algorithm.

As shown in FIG. 13B, the sample difficulty level determining unit 4030, as a separate component distinguished from the initial step unit 4010 and the additional step unit 4020, may be included in the computing device 4000 for implementing a method for automatically selecting a sample task for a worker competency test and obtaining a correct answer thereof. Specifically, the sample difficulty level determining step and the sample set generating step for each unit task may be performed after classifying each unit task into the test task candidate set and the undecided task, so that each unit task may be assigned to the difficulty level section set by the number of times of performing the task, and the test work candidate set may be randomly assigned to determine a sample set.

In addition, as shown in FIG. 13C, in another embodiment of the present invention, the sample difficulty level determining unit 4030 may be included in the initial step unit 4010 and the additional step unit 4020, so as to calculate the number of times of performing the task for each unit task and assign the difficulty level. Specifically, in the difficulty level determining step for each unit task, each unit task may be assigned and determined to a difficulty level section set by the number of times of performing the task and determined whenever each unit task is classified into the test task candidate set, and in the sample set step, the sample set may be determined by randomly assigning a test task candidate set assigned with a difficulty level.

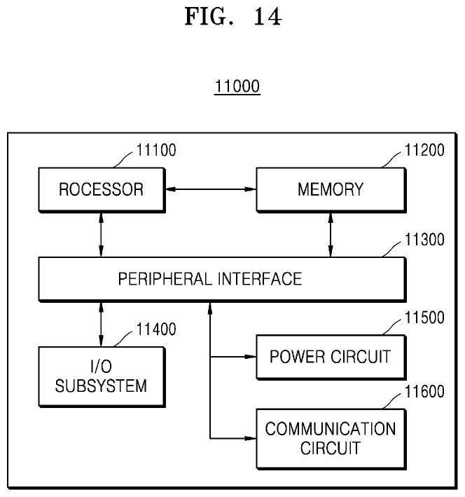

FIG. 14 schematically shows internal components of the computing device according to one embodiment of the present invention.

The computing device 1000 shown in the above-described FIG. 1 and the computing device 4000 shown in the above-described FIG. 7 may include components of the computing device 11000 shown in FIG. 14.

As shown in FIG. 14, the computing device 11000 may at least include at least one processor 11100, a memory 11200, a peripheral device interface 11300, an input/output subsystem (I/O subsystem) 11400, a power circuit 11500, and a communication circuit 11600. The computing device 11000 may correspond to the computing device 1000 shown in FIG. 1.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 11000.

The access to the memory 11200 from other components of the processor 11100 or the peripheral interface 11300, may be controlled by the processor 11100.

The peripheral interface 11300 may combine an input and/or output peripheral device of the computing device 11000 to the processor 11100 and the memory 11200. The processor 11100 may execute the software module or the instruction set stored in memory 11200, thereby performing various functions for the computing device 11000 and processing data.

The input/output subsystem may combine various input/output peripheral devices to the peripheral interface 11300. For example, the input/output subsystem may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the I/O subsystem.

The power circuit 11500 may provide power to all or a portion of the components of the terminal. For example, the power circuit 11500 may include a power failure detection circuit, a power converter or inverter, a power status indicator, a power failure detection circuit, a power converter or inverter, a power status indicator, or any other components for generating, managing, and distributing the power.

The communication circuit 11600 may use at least one external port, thereby enabling communication with other computing devices.

Alternatively, as described above, if necessary, the communication circuit 11600 may transmit and receive an RF signal, also known as an electromagnetic signal, including RF circuitry, thereby enabling communication with other computing devices.

The above embodiment of FIG. 10 is merely an example of the computing device 11000, and the computing device 11000 may have a configuration or arrangement in which some components shown in FIG. 10 are omitted, additional components not shown in FIG. 10 are further provided, or at least two components are combined. For example, a computing device for a communication terminal in a mobile environment may further include a touch screen, a sensor or the like in addition to the components shown in FIG. 10, and the communication circuit 11600 may include a circuit for RF communication of various communication schemes (such as WiFi, 3G, LTE, Bluetooth, NFC, and Zigbee). The components that may be included in the computing device 11000 may be implemented by hardware, software, or a combination of both hardware and software which include at least one integrated circuit specialized in a signal processing or an application.

The methods according to the embodiments of the present invention may be implemented in the form of program instructions to be executed through various computing devices, thereby being recorded in a computer-readable medium. In particular, a program according to an embodiment of the present invention may be configured as a PC-based program or an application dedicated to a mobile terminal. The application to which the present invention is applied may be installed in the computing device 11000 through a file provided by a file distribution system. For example, a file distribution system may include a file transmission unit (not shown) that transmits the file according to the request of the computing device 11000.

The above-mentioned device may be implemented by hardware components, software components, and/or a combination of hardware components and software components. For example, the devices and components described in the embodiments may be implemented by using at least one general purpose computer or special purpose computer, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and at least one software application executed on the operating system. In addition, the processing device may access, store, manipulate, process, and create data in response to the execution of the software. For the further understanding, some cases may have described that one processing device is used, however, it is well known by those skilled in the art that the processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, and an instruction, or a combination of at least one thereof, and may configure the processing device to operate as desired, or may instruct the processing device independently or collectively. In order to be interpreted by the processor or to provide instructions or data to the processor, the software and/or data may be permanently or temporarily embodied in any type of machine, component, physical device, virtual equipment, computer storage medium or device, or in a signal wave to be transmitted. The software may be distributed over computing devices connected to networks, so as to be stored or executed in a distributed manner. The software and data may be stored in at least one computer-readable recording medium.

The method according to the embodiment may be implemented in the form of program instructions to be executed through various computing mechanisms, thereby being recorded in a computer-readable medium. The computer-readable medium may include program instructions, data files, data structures, and the like, independently or in combination thereof. The program instructions recorded on the medium may be specially designed and configured for the embodiment, or may be known to those skilled in the art of computer software so as to be used. An example of the computer-readable medium includes a magnetic medium such as a hard disk, a floppy disk and a magnetic tape, an optical medium such as a CD-ROM and a DVD, a magneto-optical medium such as a floptical disk, and a hardware device specially configured to store and execute a program instruction such as ROM, RAM, and flash memory. An example of the program instruction includes a high-level language code to be executed by a computer using an interpreter or the like as well as a machine code generated by a compiler. The above hardware device may be configured to operate as at least one software module to perform the operations of the embodiments, and vice versa.

According to one embodiment of the present invention, since reliability information is calculated based on the task results performed by a plurality of workers on the work including each unit task, the comprehensive task results for task results can be derived with weights on the reliability information (review/task ability) of the worker. Even when the worker has not previously performed the task, the reliability information can be calculated based on the currently performed task results.

According to one embodiment of the present invention, the task result inference step and the reliability information update step may be repeatedly performed to update the reliability information of the worker so that the error value between the task result for each worker and the first comprehensive task result for the unit task corresponding to the task result for each worker is minimized, so that the reliability information for accurately reflecting the task results performed by a plurality of workers can be derived.

According to one embodiment of the present invention, a plurality of initial reliability tests may be provided to the workers, and the initial reliability information for each worker may be derived based on the test results performed by the worker, so that the initial value for updating the reliability information for each worker can be effectively allocated.

According to one embodiment of the present invention, a plurality of initial reliability tests are provided to the worker between the works including the unit task performed by the worker, so that the initial reliability information can be derived while considering the worker's concentration that changes as the worker continuously performs the tasks.

According to one embodiment of the present invention, since reliability information is calculated based on the task results performed by a plurality of workers on the work including each unit task, a sample task for the worker competence test can be automatically selected based on the task results and the reliability information on the worker.

According to one embodiment of the present invention, the initial correct answer probability deriving step and the initial test classifying step are repeatedly performed to automatically classify the unit task that meet preset criterion into the test task candidate set, so that the reliability on the task classified into the test task candidate set can be ensured among the task results performed by multiple workers.

According to one embodiment of the present invention, since a sample set for worker competence tests on multiple tasks is automatically generated, an error with the correct answer generated by the worker reliability inference scheme is compared, so that the accuracy of a review algorithm can be determined.

According to one embodiment of the present invention, since a sample set for worker competence tests on multiple tasks is automatically generated, reviews on task results by super collection users who do not need reviews may be omitted, so that costs for producing data can be reduced.

According to one embodiment of the present invention, the process of selecting a sample task and obtaining a corresponding answer for the worker competence test on multiple tasks can be performed without an examiner or expert answer, so that costs for producing data can be reduced.

Although the above embodiments have been described with reference to the limited embodiments and drawings, however, it will be understood by those skilled in the art that various changes and modifications may be made from the above-mentioned description. For example, even though the described descriptions may be performed in an order different from the described manner, and/or the described components such as system, structure, device, and circuit may be coupled or combined in a form different from the described manner, or replaced or substituted by other components or equivalents, appropriate results may be achieved.

Therefore, other implementations, other embodiments, and equivalents to the claims are also within the scope of the following claims.

What is claimed is:

1. A method for automatically deriving a test task labeled with a correct answer and a difficulty level of the task through crowdsourcing performed on a computing device having at least one processor and at least one memory, the method comprising:
an initial step comprising:
a task result receiving step of receiving task results of initial multiple workers on multiple unit tasks;
an initial task processing step of deriving a comprehensive task result of each unit task, based on initial information including the task results of the initial multiple workers, and deriving reliability information on each of the initial multiple workers, based on some or all of the comprehensive task result and the initial information;
an initial correct answer probability deriving step of deriving a correct answer probability for each answer for each of multiple unit tasks, based on the reliability information on each of the initial multiple workers determined in the initial task processing step and the task results of the initial multiple workers;
an initial test classifying step of classifying at least one unit task, in which the correct answer probability for each answer meets a preset criterion among multiple unit tasks, into a test task candidate set; and
an initial worker adding step of assigning an undecided task, which includes at least one unit task in which the correct answer probability for each answer does not meet the preset criterion among multiple unit tasks, to at least one additional worker; and
an additional step of receiving a task result by the additional worker on the undecided task, classifying a part of the undecided task into a test task candidate set, and classifying another part of the undecided tasks into the undecided task again.

2. The method of claim 1, wherein the additional step includes:
an additional task result receiving step of receiving a task result by at least one additional worker for at least one undecided task;
an additional task processing step of deriving the comprehensive task result of each undecided task based on the initial information including the task results by the initial multiple workers and the additional worker for the at least one undecided task, and deriving reliability information on each of the initial multiple workers and the at least one additional worker based on some or all of the comprehensive task result and the initial information;
an additional correct answer probability deriving step of deriving a correct answer probability for each answer for each of multiple undecided tasks, based on the reliability information on each of the initial multiple workers and the at least one additional worker determined in the additional task processing step, and the task results by the initial multiple workers and the at least one additional worker;
an additional test classifying step of classifying at least one undecided task, in which the correct answer probability for each answer meets a preset criterion among multiple undecided tasks, into a test task candidate set; and
an additional worker adding step of reassigning at least one undecided tasks, in which the correct answer probability for each answer does not meet the preset criteria among multiple undecided tasks, to the at least one additional worker.

3. The method of claim 1, wherein the additional step is performed two times or more.

4. The method of claim 1, wherein the additional step is repeatedly performed N times (N is a natural number equal to or greater than 2) until the number of remaining undecided tasks meets the preset criterion.

5. The method of claim 1, further comprising:
a sample difficulty level determining step, wherein
the sample difficulty level determining step includes determining a difficulty level of the unit task based on the number of times of performing the task for each of the at least one unit task included in the test task candidate set.

6. The method of claim 5, wherein the sample difficulty level determining step includes:
setting the difficulty level of the unit task as higher when the number of times of performing the task is increased.

7. The method of claim 5, wherein the sample difficulty level determining step includes:
stopping the additional step for the unit task in which the number of times of performing the task exceeds the maximum number of times of performing the task; and
assigning the highest difficulty level to the unit task.

8. The method of claim 1, further comprising:
a sample set generating step, wherein
each of the at least one unit task included in the test task candidate set is labeled with corresponding a difficulty level information,
a sample set generated in the sample set generating step includes at least two sub-sample sets having different difficulties, and
the sample set generating step includes assigning some or all of the at least one unit task included in the test task candidate set to a corresponding sub-sample set based on the difficulty level information.

9. The method of claim 1, wherein the initial processing step includes:
repeatedly updating reliability information on each of the initial multiple workers until error values of the comprehensive task results of the initial multiple workers converges to a specific value.

10. The method of claim 1, wherein the preset criterion includes whether the at least one correct answer probability for each correct answer exceeds a first threshold value.

11. The method of claim 1, wherein the preset criterion includes whether at least one indicator for a difference between multiple correct answers probabilities exceeds a second threshold value.

12. A system for automatically deriving a test task labeled with a correct answer and a difficulty level of the task through crowdsourcing, the system performing the steps comprising:
an initial step comprising:
a task result receiving step of receiving task results of initial multiple workers on multiple unit tasks;
an initial task processing step of deriving a comprehensive task result of each unit task based on initial information including the task results of the initial multiple workers, and deriving reliability information on each of the initial multiple workers based on some or all of the comprehensive task result and the initial information;
an initial correct answer probability deriving step of deriving a correct answer probability for each answer for each of multiple unit tasks, based on the reliability information on each of the initial multiple workers determined in the initial task processing step and the task results of the initial multiple workers;
an initial test classifying step of classifying at least one unit task, in which the correct answer probability for each answer meets a preset criterion among multiple unit tasks, into a test task candidate set; and
an initial worker adding step of assigning an undecided task, which includes at least one unit task in which the correct answer probability for each answer does not meet the preset criterion among multiple unit tasks, to at least one additional worker; and
an additional step of receiving a task result by the additional worker on the undecided task, classifying a part of the undecided task into a test task candidate set, and classifying another part of the undecided tasks into the undecided task again.

13. A computer-readable medium for implementing a method for automatically deriving a test task labeled with a correct answer and a difficulty level of the task through crowdsourcing performed on a computing device having at least one processor and at least one memory, the computer-readable medium storing instructions for allowing a computing device to perform the steps comprising:
an initial step comprising:
a task result receiving step of receiving task results of initial multiple workers on multiple unit tasks;
an initial task processing step of deriving a comprehensive task result of each unit task based on initial information including the task results of the initial multiple workers, and deriving reliability information on each of the initial multiple workers based on some or all of the comprehensive task result and the initial information;
an initial correct answer probability deriving step of deriving a correct answer probability for each answer for each of multiple unit tasks, based on the reliability information on each of the initial multiple workers determined in the initial task processing step and the task results of the initial multiple workers;
an initial test classifying step of classifying at least one unit task, in which the correct answer probability for each answer meets a preset criterion among multiple unit tasks, into a test task candidate set; and
an initial worker adding step of assigning an undecided task, which includes at least one unit task in which the correct answer probability for each answer does not meet the preset criterion among multiple unit tasks, to at least one additional worker; and
an additional step of receiving a task result by the additional worker on the undecided task, classifying a part of the undecided task into a test task candidate set, and classifying another part of the undecided tasks into the undecided task again.
